(19) United States
(12) Patent Application Publication
(10) Pub. No.: US 2025/0253998 A1
(43) Pub. Date: Aug. 7, 2025

(54) METHODS, ARCHITECTURES, APPARATUSES AND SYSTEMS FOR DATA-DRIVEN CHANNEL STATE INFORMATION (CSI) PREDICTION

(71) Applicant: InterDigital Patent Holdings, Inc., Wilmington, DE (US)

(72) Inventors: Satyanarayana Katla, London (GB); Ahmet Serdar Tan, London (GB); Patrick Tooher, Montreal (CA); Tejaswinee Lutchoomun, Montreal (CA); Arman Shojaeifard, London (GB); Yugeswar Deenoo, Chalfont, PA (US); Moon-IL Lee, Melville, NY (US); Mihaela Beluri, Jericho, NY (US); Ibrahim Hemadeh, Hemel Hempstead (GB); Mohamed Salah Ibrahim, Chesterbrook, PA (US); Akshay Malhotra, San Jose, CA (US)

(21) Appl. No.: 18/856,796

(22) PCT Filed: Apr. 14, 2023
(86) PCT No.: PCT/US2023/018599

§ 371 Date: Oct. 14, 2024

Related U.S. Application Data
(60) Provisional application No. 63/410,779, filed on Sep. 28, 2022.
(60) Provisional application No. 63/331,286, filed on Apr. 15, 2022.

(51) Int. Cl. H04L 5/00; H04B 7/06; H04B 17/373; H04W 72/0446; H04W 72/21

(52) U.S. Cl. CPC H04L 5/005; H04B 7/0626; H04B 17/373; H04W 72/0446; H04W 72/21

(57) ABSTRACT

Procedures, methods, architectures, apparatuses, systems, devices, and computer program products directed to data-driven channel state information (CSI) prediction in wireless systems are disclosed. In an embodiment, an apparatus may be configured to receive, from a network node, a plurality of reference signals transmitted during a time window; determine, based on a trained artificial intelligence (AI) model, a plurality of channel state information (CSI) associated with the plurality of reference signals; generate a report comprising the plurality of CSI; and/or transmit the report to the network node.

### CROSS-REFERENCE TO RELATED APPLICATIONS

This application claims the benefit of U.S. Provisional Patent Application Nos. (i) 63/331,286 filed Apr. 15, 2022, and (ii) 63/410,779 Sep. 28, 2022; each of which is incorporated herein by reference.

### BACKGROUND

The present disclosure is generally directed to the fields of communications, software and encoding, including, for example, to methods, architectures, apparatuses, systems directed to data-driven channel state information (CSI) prediction in wireless systems.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of CSI measurement setting;

FIG. 3 illustrates a codebook-based precoding with feedback information;

FIG. 4 illustrates an example of recurrent neural networks (RNN) architecture;

FIG. 5 illustrates a signal flow for aperiodic WTRU reporting of predicted CSI samples;

FIG. 6 illustrates a timeline for WTRU reporting of predicted CSI samples in a single report;

FIG. 7 illustrates a WTRU method for reporting of predicted CSI samples in a single report;

FIG. 8 illustrates a timeline for WTRU reporting of predicted CSI samples in a single report;

FIG. 9 illustrates a WTRU method for reporting of predicted CSI samples in a single report;

FIG. 10 illustrates a signal flow for the periodic reporting of predicted CSI samples;

FIG. 11 illustrates another signal flow for the periodic reporting of predicted CSI samples;

FIG. 12 illustrates an example timeline for a WTRU reporting;

FIG. 13 illustrates a signal flow for aperiodic reporting of predicted CSI samples;

FIG. 14 illustrates an example timeline for a WTRU reporting of dynamic predicted CSI samples;

FIG. 15 illustrates WTRU reports CSI prediction error event;

FIG. 16 illustrates an example timeline for prediction error event;

FIG. 17 illustrates an example of a method for CSI prediction for a wireless system; and

FIG. 18 illustrates another example of a method for CSI prediction for a wireless system.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

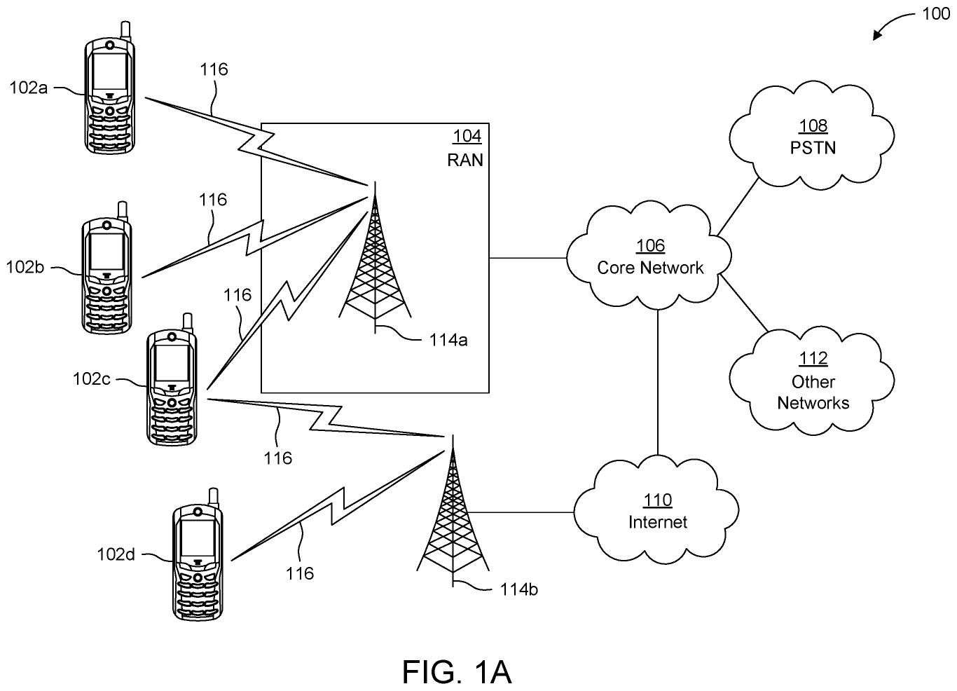

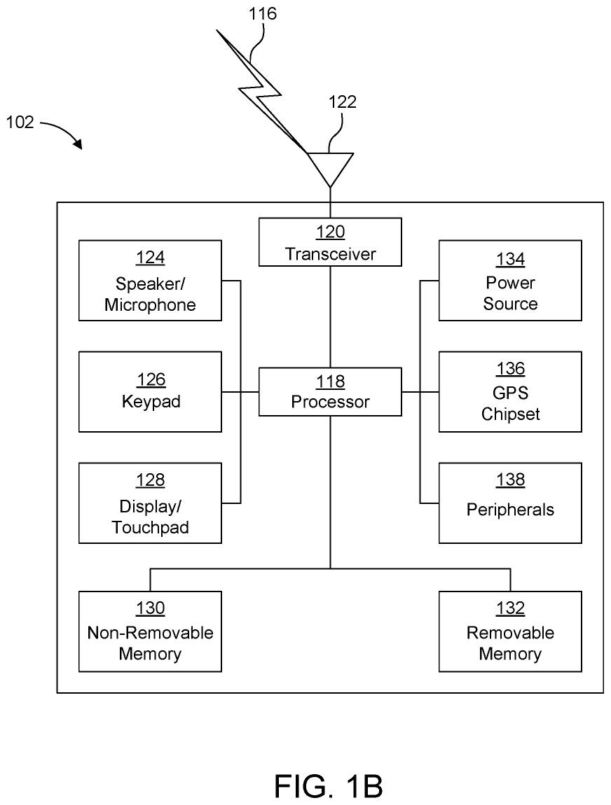

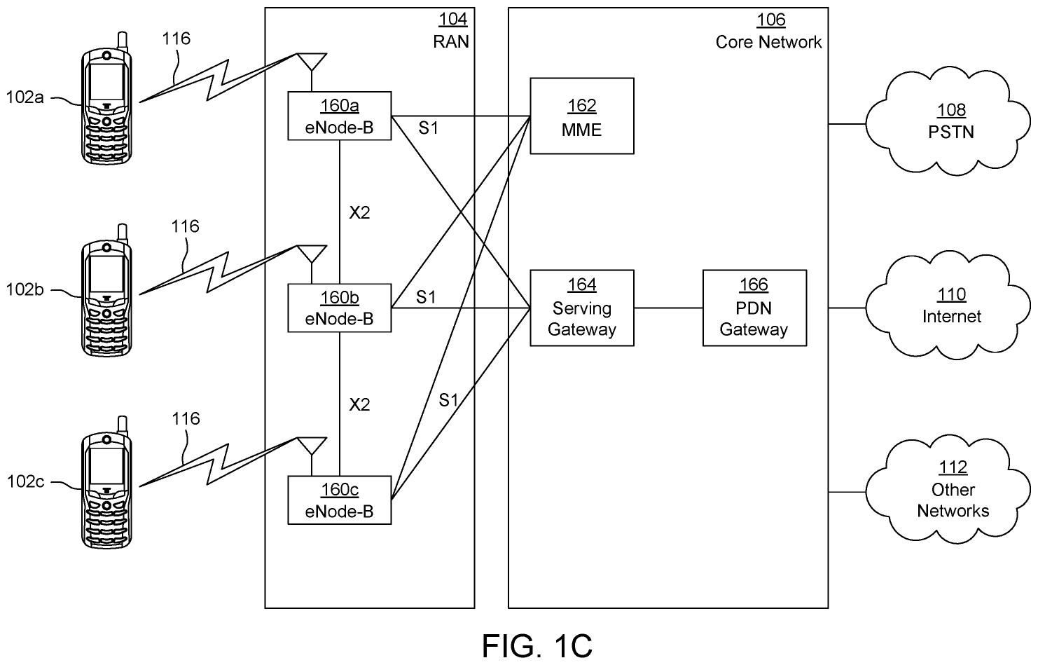

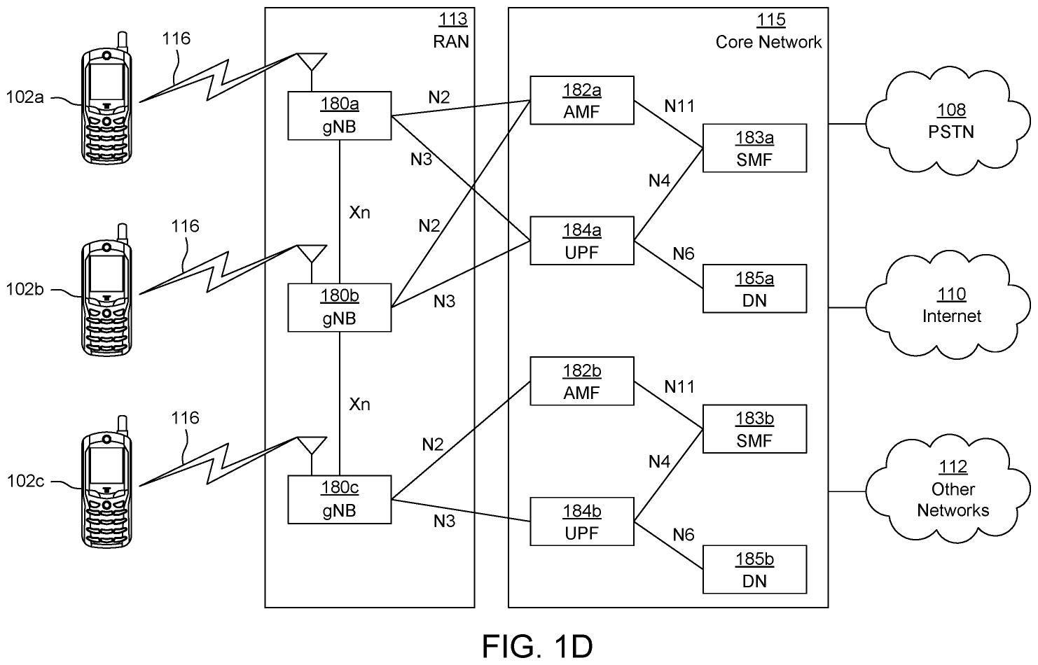

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Methods to reduce the CSI feedback reporting overhead and/or the CSI-RS overhead, for example, by using WTRU based CSI prediction may be provided. The WTRU may predict future CSI reports based on the current and/or past CSI-RS samples.

For downlink scheduling and link adaptation approaches for both single user (SU) and multiple user (MU) multiple input multiple output (MIMO), accurate knowledge of the channel may be used (e.g., is needed). This may be achieved, for example, using DL CSI reference signals (RSs) to enable channel estimation at the WTRU, and by feeding back the estimated CSI (e.g., channel quality indicator (CQI); rank indicator (RI); precoding matrix index (PMI); layer indicator (LI)) in the WTRU CSI reports. As 5G NR may support up to 64 antenna ports, there may be a large overhead associated with the DL CSI-RS reference signals, and/or the corresponding UL CSI reports. This overhead may increase, for example, as the system bandwidth and/or the number of antennas may increase in beyond fifth generation (B5G) Massive MIMO systems.

CSI prediction may be used to provide CSI reports using a reduced number of CSI-RS signals; traditional (model-based) approaches to CSI prediction may include autoregressive models (AR), but these approaches may be sensitive to impairments. By contrast, recent research on data-driven CSI prediction (for example using recurrent neural networks-RNN), shows promising results.

While the recent research on machine learning (ML)-based CSI prediction shows promising performance of the predictors, it does not address how to integrate the ML-based CSI prediction in the 3GPP framework to reduce the overhead (CSI-RS overhead and/or CSI reporting overhead).

In the time domain, CSI-RS resources may be configured either periodic, semi-persistent, or aperiodic. Semi-persistent CSI-RS is similar to periodic CSI-RS, except that the resource may be (de)-activated by media access control elements MAC CEs; and the WTRU may report related measurements (e.g., only) if (e.g., when) the resource is activated. For Aperiodic CSI-RS, the WTRU may be triggered to report measured CSI-RS, for example, on physical uplink shared channel (PUSCH) by request in a via downlink control information (DCI). Periodic reports may be carried over the PUCCH, while semi-persistent reports may be carried either on physical uplink control channel (PUCCH) or PUSCH.

One or more of the following may be provided: techniques to reduce the UL CSI reporting overhead, for example, by signaling the predicted CSI for L (>1) temporal samples in a single reporting opportunity; techniques to use CSI prediction at the WTRU to reduce the CSI-RS overhead; techniques to report the prediction accuracy as a function of the look-ahead window; techniques wherein the WTRU determine need for the CSI prediction ML model re-training.

### Single-Shot Reporting of a Batch of L Predicted CSI (Single UL Grant)

An exemplary embodiment describes a method performed by a WTRU to reduce the CSI overhead by using CSI prediction, the method comprising any of the following actions:
The WTRU may receive the look-ahead window size request from the network.
The WTRU may receive transmit to the network, the CSI prediction look-ahead window size “L_max” as well as the number of CSI-RS temporal samples, N, for example, for (e.g., required) for building historical CSI:
   The CSI prediction look-ahead window size may use (e.g., depend on) the trained CSI prediction model.
   The WTRU may report the expected prediction accuracy as a function of the look-ahead (for up to L_max look-ahead).
The WTRU may be configured for CSI prediction with L look-ahead window size (L<=L_max):
   The WTRU may be configured with a prediction accuracy threshold.
The WTRU may receive the N CSI-RS samples, for example, for building the historical CSI data:
   The WTRU may report legacy CSI, for example, while building the historical CSI data.
The WTRU may employ the CSI predictor model and/or may obtain the look-ahead predicted L CSI values.
The WTRU may transmit CSI prediction complete indication to the BS (e.g., eNB, gNB) and/or may request the network for uplink grant.
The WTRU may receive the uplink grant from the network.
The WTRU may send the L predicted CSI values to the network, for example, in single uplink grant via PUCCH/PUSCH.
In one embodiment, the WTRU may receive the CSI-RS from the network to keep track/check the accuracy of CSI prediction. The WTRU may not send any CSI reports, for example, until the look-ahead window size elapsed:
   This may reduce the overhead in the uplink.
   In one embodiment, the BS (e.g., eNB, gNB) may transmit periodic CSI-RS.

### WTRU Reports CSI Prediction Error Event

The WTRU may measure the difference between the predicted and the actual CSI for slot “k” within the look-ahead window, e.g., to measure the prediction accuracy. If the difference exceeds a configured threshold, the WTRU may report (e.g., only) the delta from the previously reported CSI for slot “k”, and/or may transmit re-training request to the BS (e.g., eNB, gNB). An exemplary embodiment describes a method performed by a WTRU comprising any of the following actions:
The WTRU may receive the CSI-RS from the network, and/or may compute the error between the predicted CSI and the true CSI.
The WTRU may report to the network, for example, if prediction error is above threshold.
The WTRU may receive from the network, request to send differential CSI values for subsequent look-ahead time slots:
   The WTRU may receive from the network, the retraining request for CSI prediction:
      The WTRU may receive the CSI-RS samples for retraining.
      The WTRU may update the prediction model weights.
      The WTRU may send finished training ACK, for example, if the prediction error is below threshold within the configured time for retraining.
      The WTRU may follow procedures described in the previous embodiment.
The WTRU may compute the difference between the predicted CSI values and the true CSI values and/or may transmit the differential CSI to the network.
The WTRU may receive the data from the network, for example, based on the updated CSI values.

CSI may include any of the following: a channel quality index (CQI), a rank indicator (RI), a precoding matrix index (PMI), a layer 1 (L1) channel measurement (e.g., reference signal received power (RSRP), such as L1 reference signal received power (L1-RSRP) or signal to interference and noise ratio (SINR)), a CSI-RS resource indicator (CRI), a synchronization signal/physical broadcast channel (SS/PBCH) block resource indicator (SSBRI), a layer indicator (LI) and/or any other measurement quantity measured by the WTRU from the configured reference signals (e.g., CSI-RS or SS/PBCH block or any other reference signal).

### CSI Reporting Framework

A WTRU may be configured to report the CSI through the uplink control channel on PUCCH, or per the BS's (e.g., eNB, gNB) request on an UL PUSCH grant. Depending on the configuration, CSI-RS can cover the full bandwidth of a bandwidth part (BWP) or just a fraction of it. Within the CSI-RS bandwidth, CSI-RS can be configured in each physical resource block (PRB) or every other PRB. In the time domain, CSI-RS resources can be configured either periodic, semi-persistent, or aperiodic. Semi-persistent CSI-RS may be similar to periodic CSI-RS, except that the resource can be (de)-activated by MAC CEs; and the WTRU may report related measurements (e.g., only) if (e.g., when) the resource is activated. For Aperiodic CSI-RS, the WTRU may be triggered to report measured CSI-RS on PUSCH by request in a DCI. Periodic reports may be carried over the PUCCH, while semi-persistent reports can be carried either on PUCCH or PUSCH. The reported CSI may be used by the scheduler when allocating optimal resource blocks possibly based on any of channel's time-frequency selectivity, determining precoding matrices, beams, transmission mode and selecting suitable MCSs. The reliability, accuracy, and timeliness of WTRU CSI reports may be critical to meeting URLLC service requirements.

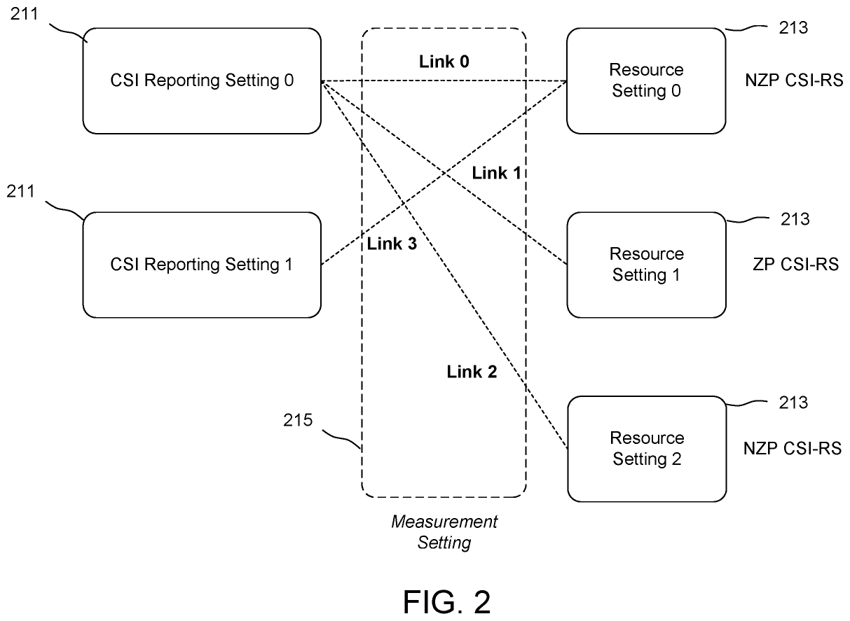

A WTRU may be configured with a CSI measurement setting which may include one or more CSI reporting settings, resource settings, and/or a link between one or more CSI reporting settings and one or more resource settings. FIG. 2 shows an example of a configuration for CSI reporting settings, resource settings, and link.

In a CSI measurement setting, one or more of the following configuration parameters may be provided:
N≥1 CSI reporting settings 211, M≥1 resource settings 213, and a CSI measurement setting 215 which links the N CSI reporting settings 211 with the M resource settings 213.
A CSI reporting setting 211 may include any of the following:
   Time-domain behavior: aperiodic or periodic/semi-persistent.
   Frequency-granularity, at least for PMI and CQI.
   CSI reporting type (e.g., PMI, CQI, RI, CRI, etc.).
   If a PMI is reported, PMI Type (Type I or II) and codebook configuration.
A resource setting 213 may include any of the following:
   Time-domain behavior: aperiodic or periodic/semi-persistent.
   RS type (e.g., for channel measurement or interference measurement).
   S≥1 resource set(s) and each resource set can contain Ks resources.
A CSI measurement setting 215 may include any of the following:
   One CSI reporting setting.
   One resource setting.
   For CQI, a reference transmission scheme setting.
For CSI reporting for a component carrier, any of the following frequency granularities may be supported:
   Wideband CSI.
   Partial band CSI.
   Sub band CSI.

### Codebook Based Precoding

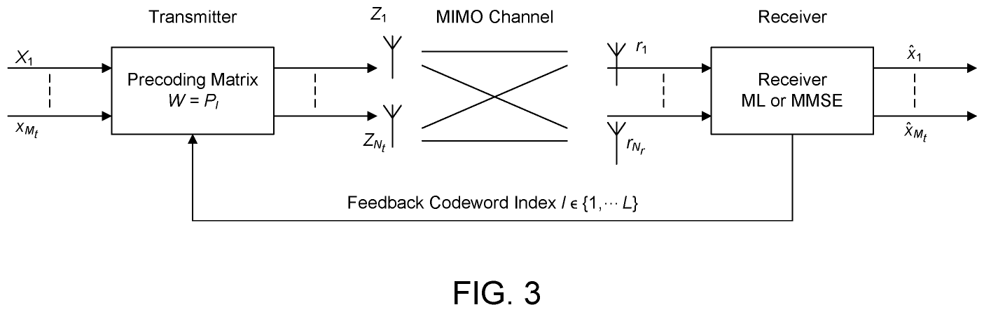

FIG. 3 shows a basic concept of codebook-based precoding with feedback information. The feedback information may include a PMI which may be referred to as a codeword index in the codebook as shown in the figure.

As shown in FIG. 3, a codebook may include a set of precoding vectors/matrices for each rank and the number of antenna ports, and each precoding vectors/matrices has its own index so that a receiver may inform preferred precoding vector/matrix index to a transmitter. The codebook-based precoding may have performance degradation due to its finite number of precoding vector/matrix as compared with non-codebook-based precoding. A codebook-based precoding may provide be lower control signaling/feedback overhead. Following table 1 shows an example of codebook for 2Tx.

TABLE 1
Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ] \vert$ |
| 3 | $\frac{1}{\sqrt{2}} [ \begin{matrix}1 \\ - j\end{matrix} ]$ | — |

### CSI Processing Criteria

A CSI processing unit (CPU) may be referred to as a minimum CSI processing unit and a WTRU may support one or more CPUs (e.g., N CPUs). A WTRU with N CPUs may estimate N CSI feedbacks calculation in parallel, wherein N may be a WTRU capability. If a WTRU is requested to estimate more than N CSI feedbacks at the same time, the WTRU may (e.g., only) perform high priority N CSI feedbacks and the rest may be not estimated.

The starts and ends of a CPU may be determined based on the CSI report type (e.g., aperiodic, periodic, semi-persistent) as following:
For aperiodic CSI report, a CPU starts to be occupied from the first OFDM symbol after the Physical Downlink Control channel (PDCCH) trigger until the last OFDM symbol of the PUSCH carrying the CSI report.
For periodic and semi-persistent CSI report, a CPU starts to be occupied from the first OFDM symbol of one or more associated measurement resources (not earlier than CSI reference resource) until the last OFDM symbol of the CSI report.

The number of CPUs occupied may be different based on the CSI measurement types (e.g., beam-based or non-beam based) as following:
Non-beam related reports:
   Ks CPUs when Ks CSI-RS resources in the CSI-RS resource set for channel measurement.
Beam-related reports (e.g., “cri-RSRP”, “ssb-Index-RSRP”, or “none”):
   1 CPU irrespective the number of CSI-RS resource in the CSI-RS resource set for channel measurement due to the CSI computation complexity is low; and
   “none” is used for P3 operation or aperiodic Tracking Reference Signal (TRS) transmission.
For an aperiodic CSI reporting with a single CSI-RS resource, 1 CPU is occupied.
For a CSI reporting Ks CSI-RS resources, Ks CPUs may be occupied as WTRU needs to perform CSI measurement for each CSI-RS resource.

When the number of unoccupied CPUs (N_u) is less than required CPUs (N_r) for CSI reporting, any of the following WTRU behavior may be used:
The WTRU may drop N_r-N_u CSI reporting based on priorities in the case of Uplink Control Information (UCI) on PUSCH without data/Hybrid Automatic Repeat reQuest (HARQ)
The WTRU may report dummy information in Nr-Nu CSI reporting based on priorities in other case to avoid rate-matching handling of PUSCH.

### Artificial Intelligence (AI)

Artificial intelligence (AI) may be broadly defined as the behavior exhibited by machines. Such behavior may e.g., mimic cognitive functions to sense, reason, adapt and act.

### Machine Learning (ML)

Machine learning may refer to type of algorithms that solve a problem based on learning through experience (‘data’), without explicitly being programmed (‘configuring set of rules’). Machine learning (ML) can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with (e.g., only) labeled training data).

### Deep Learning (DL)

Deep learning refers to class of machine learning algorithms that employ artificial neural networks (specifically deep neural networks (DNNs)) which were loosely inspired from biological systems. The DNNs are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

### AI/ML Based CSI Prediction

RNN have recently emerged as a popular approach for AI/ML based CSI prediction, due to their strong time series prediction capabilities. RNNs are neural networks consisting of an input layer, an output layer and one (or more) hidden layers, where the hidden layers leverage memory of previous states to predict future samples.

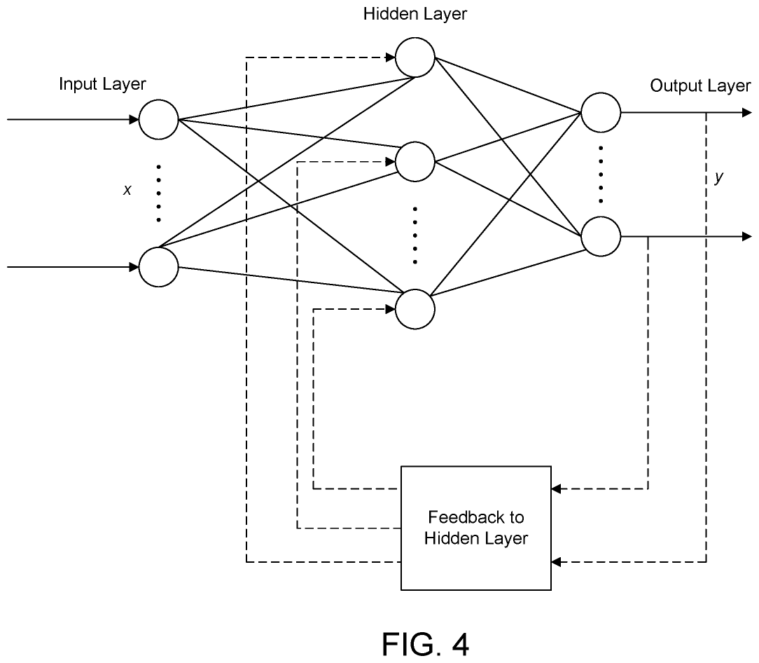

One example of RNN architecture is shown in FIG. 4, where the vector of hidden states may be a function of current inputs and previous RNN output, x(t) represents the vector at the RNN input at time t, and y(t) represents the RNN output vector at time t.

When the RNN is used for channel/CSI prediction, the input x may comprise (e.g., consist of) a sequence of N previous consecutive channel estimates, Ã(t), Ã(t−1), . . . \tilde{H}(t−N+1). To generate the RNN input, the estimated channel/CSI may be fed to a tapped delay line. Depending on the RNN architecture, the input sequence of N channel estimates may be converted from matrix to vector form. The RNN output represents the predicted channel/CSI at time t+L, Ĥ(t+L). An example of loss function used to train the RNN is [symbol] =∥Ĥ(t+L)−H(t+L)∥_{F}², where Ĥ(t+L) represents the predicted channel at time t+L, and Ĥ(t+L) represents the desired output of the network (the actual channel at time t+L) and the operator ∥ ∥_{F} indicates the Frobenius (Euclidean) norm. The loss function thus defined is used to train the RNN.

For downlink scheduling and link adaptation purposes for both SU- and MU-MIMO, accurate knowledge of the channel may be used (e.g., needed). This may be achieved using DL CSI-RS reference signals to enable channel estimation at the WTRU, and by feeding back the estimated CSI (e.g., CQI, PMI, RI, LI) in the WTRU CSI reports. As 5G NR may support up to 64 antenna ports, there may be a large overhead associated with the DL CSI-RS reference signals, and the corresponding UL CSI reports. This overhead may be expected to further increase as the system bandwidth and the number of antennas may increase in B5G Massive MIMO systems.

AI/ML based approaches to channel prediction have emerged with potentially promising performance. However, there are currently no mechanisms to use these in the 3GPP framework to reduce the CSI overhead.

One or more of the following may be provided: techniques to use AI/ML-based CSI prediction at the WTRU to reduce the CSI reporting overhead; techniques to use AI/ML-based CSI prediction at the WTRU to reduce the CSI-RS overhead; techniques at the WTRU to determine need for the CSI prediction ML model re-training, and techniques at the WTRU to report the CSI during the on-line training.

In one or more embodiments described herein, the term CSI value or predicted CSI value or CSI report may refer to WTRU feedback including, but not limited to any of the following:
Implicit channel state information e.g., CQI, RI, PMI;
Explicit channel state information e.g., channel matrix, covariance matrix, a representation of principle components thereof, coherence time, Coherence BW, Doppler spread, or any other statistics derived from the channel matrix;
Any other measurement quantity measured by the WTRU from the configured reference signals (e.g., CSI-RS or SS/PBCH block or any other reference signal), L1 channel/interference measurement (e.g., RSRP such as L1-RSRP, or SINR), CRI, SSBRI, LI etc.

### Representative AI/ML-Based CSI Prediction

### AI/ML-Based CSI Prediction Capability

A WTRU may support AI/ML-based CSI prediction, for example using Recurrent neural networks (RNN) or Long Short-Term Memory networks (LSTM) AI/ML models or the like. The AI/ML CSI prediction model may use a number of “N” consecutive historical samples of the channel response to determine the predicted CSI. Based on the accumulated CSI historical information, the AI/ML CSI model may predict CSI values for up to “L” future time samples (also referred to as the “look-ahead window”).

The “N” historical CSI values may be sampled at time slot or multiple (e.g., more than 1) periodicity. In one embodiment, the historical CSI values are sampled per the configured periodicityAndOffset parameter.

The AI/ML-based CSI prediction capability of the WTRU may be reported in a radio resource control (RRC) message, for example as part of the UECapabilityInformation message. Parameters that describe the WTRU CSI prediction capability may include any of the following:
AI/ML model type, e.g., RNN, LSTM or the like;
AI/ML model ID, which may indicate the model size;
The length of the CSI history buffer (“N”) used (e.g., needed) for prediction;
The sampling period for the CSI historical information/predicted CSI values;
The maximum length of the CSI prediction window (maximum look-ahead window, LAmax); and
Training dataset information, which may include information on the characteristics of the channel model that was used to train the AI/ML CSI predictor (for example delay spread, coherence bandwidth, coherence time, Doppler, etc.).

Additionally, the WTRU CSI prediction capability may also include information regarding the expected prediction accuracy for samples within the (max) look-ahead window. For example, a metric for the prediction accuracy may the normalized mean squared error (NMSE) between the predicted CSI at time “k” (where “k” is within the look-ahead window, 1≤k≤LAₘₐₓ) and the actual CSI at time “k”. Other metrics for the CSI prediction accuracy may include the cosine similarity as described above.

### AI/ML-Based CSI Prediction Configuration Parameters

The CSI prediction capable WTRU may be configured to perform CSI prediction. The WTRU may be configured for periodic, semi-persistent or aperiodic CSI. The configuration may include any of the following:
The target look-ahead window “L” for CSI prediction (smaller than or equal to the maximum look-ahead window capability LAmax supported by the WTRU, L≤LAₘₐₓ)
The prediction error metric and/or the prediction error threshold: for example, the WTRU may be configured to report the NMSE as the prediction accuracy metric, and may be configured with a prediction error threshold (e.g., a NMSE threshold) to detect prediction error events.
The CSI-RS configuration:
   For example, the WTRU may be configured for periodic CSI-RS
   In another example, the WTRU may be configured for sets of bursty CSI-RS, for example to enable the CSI prediction engine to build the CSI historical buffer to perform the prediction. If (e.g., when) the WTRU is configured with sets of bursty CSI-RS, the WTRU may be provided with CSI-RS burst information (such as start, duration, etc.)
The CSI-RS configuration may include a time offset “k” inside the look-ahead (prediction) window, where the CSI-RS are transmitted, and the WTRU may measure the prediction accuracy/prediction error.

### CSI Feedback Reporting Configuration

The CSI prediction capable WTRU may be configured to report the CSI feedback. The CSI reporting type may be expanded to include legacy CSI reports, and predicted CSI reports, as well as implicit and/or explicit CSI.

The WTRU may be configured to report the predicted CSI, for example while the prediction error is smaller than a configured threshold. The WTRU may report legacy CSI, for example while the WTRU collects CSI historical data to enable prediction. In one embodiment, the WTRU may report legacy CSI during the re-training of the CSI prediction AI/ML model. The WTRU may indicate whether the reported CSI is legacy or predicted.

If configured, the WTRU may measure the prediction error metric at time “k” within the look-ahead window and may report it with the CSI feedback report.

### Representative CSI Prediction

### Single Shot Reporting of L Predicted CSI Values

### WTRU Procedure to Calculate and Report L Predicted CSI Values in a Single Report; Based on Periodic CSI-RS Transmissions

### Aperiodic Reporting of L Predicted CSI Values:

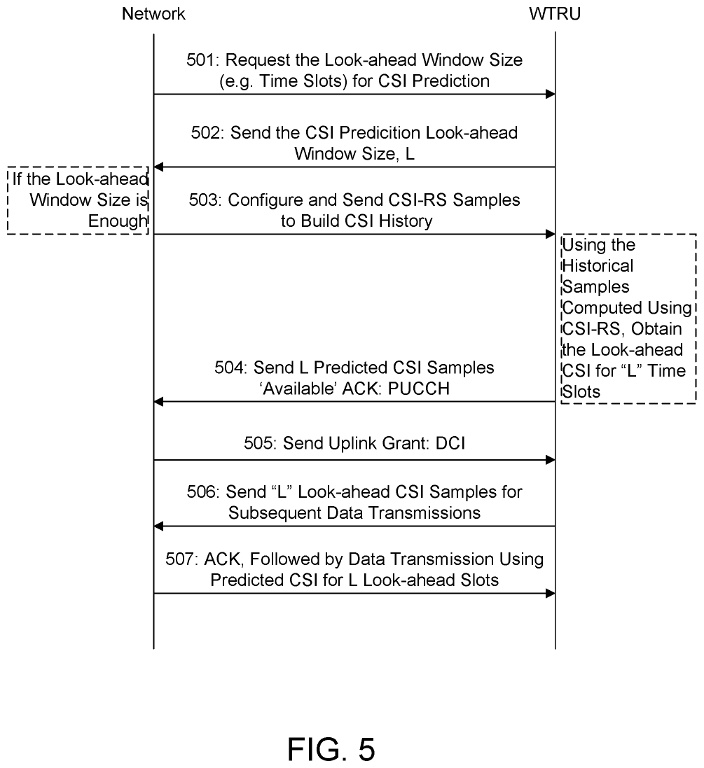

The signaling procedure of aperiodic report of L predicted CSI values is shown in FIG. 5. In this option, the CSI-RS can still be periodic transmission, while the CSI reporting is aperiodic as shown in FIG. 4. The rationale for having periodic CSI-RS transmission may be to build the RNN buffer for historical CSI samples, which may be periodically updated using the periodic CSI-RS transmissions.

According to embodiments, in a step 501, the WTRU may receive the look-ahead window size request from the network (e.g., a network node). In a step 502, the WTRU may transmit to the network (e.g., the network node), the CSI prediction look-ahead window size L, as well as the number of CSI-RS temporal samples, N, for example, for (e.g., required) for building historical CSI:
The CSI prediction look-ahead window size may use (e.g., depend on) the trained CSI prediction model.
The WTRU may report the expected prediction accuracy as a function of the look-ahead (for up to L_max look-ahead).

For example, if the look-ahead window size L is enough, in a step 503, the network (e.g., the network node) and/or the WTRU may be configured for CSI prediction with L look-ahead window size (L<=L_max). The WTRU may receive the N CSI-RS samples, for example, for building the historical CSI data. The WTRU may report legacy CSI, for example, while building the historical CSI data.

In a step 504, the WTRU relying on the “N” historical CSI samples computed using CSI-RS, may employ RNN based CSI prediction model, where the WTRU may predict “L” CSI samples ahead in time. The WTRU (e.g., upon) predicting the CSI for a look-ahead window size of L may send an acknowledgement (ACK), for example, to the base station (BS), indicating that L CSI predicted samples are available. In a step 505, the BS based on the transmission requirements (e.g., other scheduled users, resources available, etc.) may send the uplink grant to the WTRU for CSI reporting via downlink control information (DCI).

In a step 506, the WTRU after receiving the uplink grant, for example, via DCI, may report the L predicted CSI values, for example, in a single PUSCH. This may reduce the overhead significantly in terms of the number of uplink grants to avail predicted CSI values.

In a step 507, the network (e.g., the network node) may send an ACK to the WTRU, followed by data transmission using the predicted CSI for L look-ahead slots.

In one embodiment, the WTRU may receive in DCI a dynamic indication of the number of predicted CSI values to be sent in the aperiodic CSI report. The WTRU may be configured to transmit min (L, dynamic indication in DCI) predicted CSI values in the associated aperiodic CSI report.

### Periodic Reporting of L Predicted CSI Values:

The WTRU upon predicting the CSI for a look-ahead window size of L using the historical CSI samples, the WTRU may report the L predicted CSI samples on the periodically available PUCCH:
In one embodiment, when transmitting periodic reports on PUCCH, the WTRU may be configured to transmit implicit CSI values (e.g., CQI, PMI, RI etc.). This may be motivated by limited capacity of PUCCH, and hence may not be desirable for larger reporting payloads such as full CSI matrix.

In this option, both CSI-RS and CSI reporting may be periodic.

### Semi-Persistent Reporting of L Predicted CSI Values:

The WTRU may transmit L predicted CSI samples on the periodically assigned PUCCH resource. In semi-persistent reporting, the periodic reporting may be activated/deactivated by MAC CE:
The semi-persistent reporting may be employed either on periodically assigned PUCCH resource or semi-persistently allocated PUSCH:
   The PUCCH resource may be used for implicit CSI that is PMI, RI, CQI, LI.
   The PUSCH resource may be used for explicit CSI, that is, full CSI matrix.

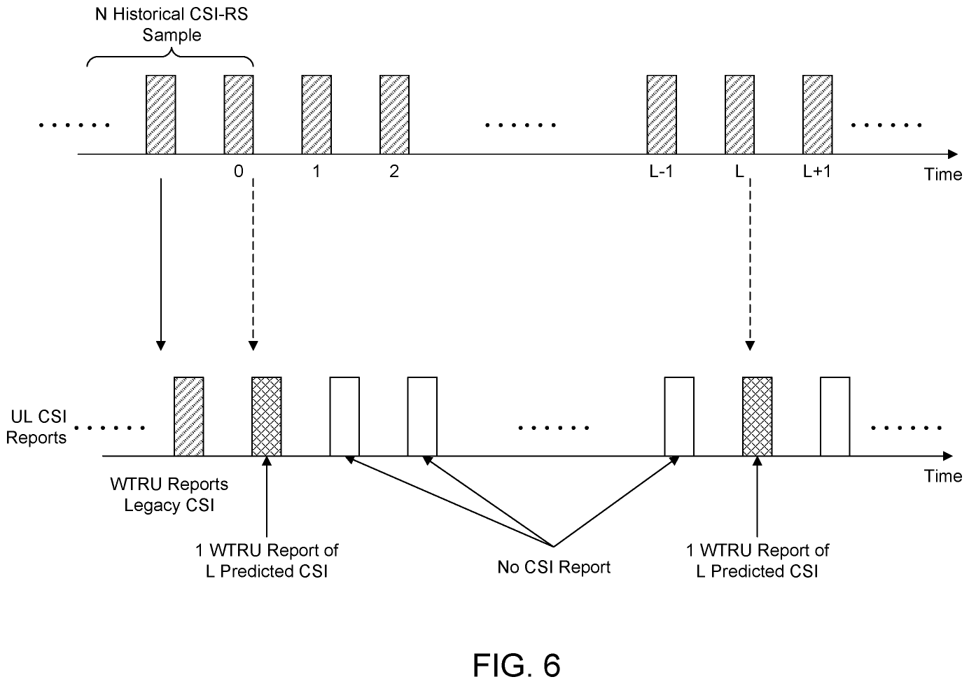

An example timeline for the single-shot (aperiodic) reporting of L predicted CSI samples is shown in FIG. 6, where periodic CSI-RS transmission is assumed.

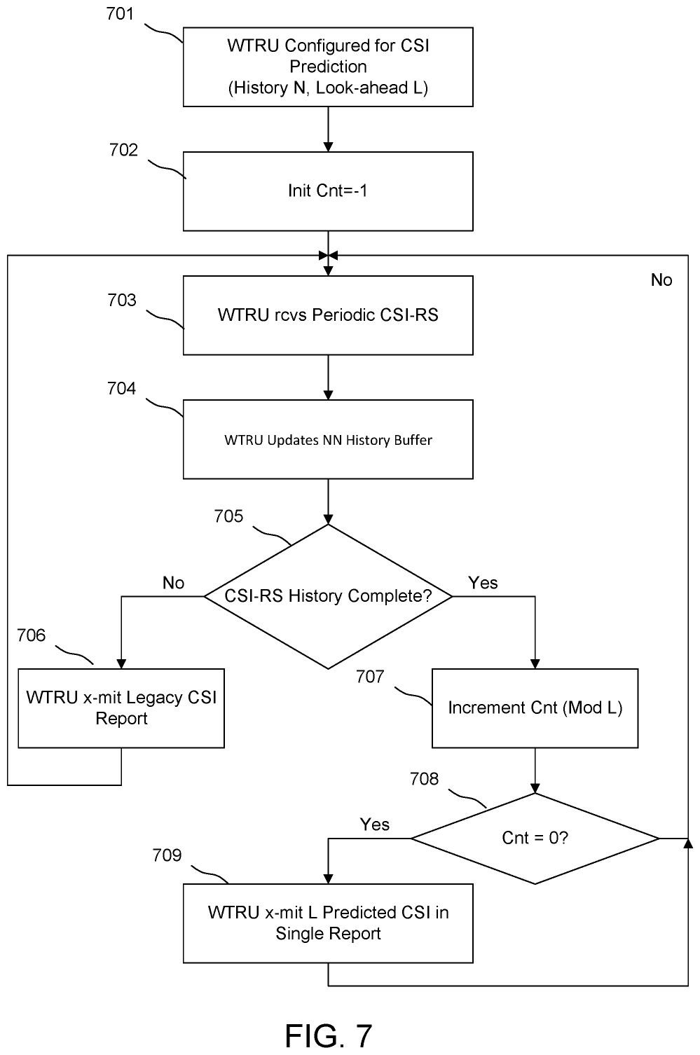

An example procedure for reporting the L predicted CSI values in a single report is shown in FIG. 7.

In a step 701, the WTRU may be configured for CSI prediction (for example with the CSI prediction look-ahead window size L, as well as the number of CSI-RS temporal samples, N, for example, for (e.g., required) for building the CSI history buffer). In a step 702, a counter may be initialized to a default value (for example “1”). In a step 703, the WTRU may receive periodic CSI-RS samples, for example, for updating the CSI history buffer in a step 704. In a step 705, the WTRU may determine if the CSI history buffer is complete. If the CSI history buffer is not complete, in a step 706, the WTRU may transmit legacy CSI report. If the CSI history buffer is complete, in a step 707, the counter may be incremented for example with the modulate of the look-ahead window size L. If the counter is equal to zero, in a step 708, the WTRU may transmit predicted CSI in a single report and the procedure may return to step 703. If the counter is not equal to zero, the procedure may return to step 703.

In one or more embodiments, the WTRU may determine the type of predicted CSI (implicit or explicit) as a function of UL resources allocated for CSI feedback. For e.g., when allocated/granted/configured with PUSCH resources or PUCCH resources payload whose size is below a preconfigured threshold, the WTRU may transmit implicit CSI value in the CSI report. For e.g., when allocated/granted/configured with PUSCH resources or when PUCCH resources whose payload size is above a preconfigured threshold, the WTRU may transmit explicit CSI in the report. In some solutions, the WTRU may be preconfigured (e.g., as part of CSI report config) for the type of predicted CSI (e.g., implicit or explicit) to be reported. The WTRU may determine the number of predicted CSI values to be reported based on the payload size of allocated/granted/configured PUCCH and/or PUSCH resources.

### WTRU Procedure to Calculate and Report L Predicted CSI Values in a Single Report; No Periodic CSI-RS Transmissions

To reduce the overhead both in the uplink and downlink, there may be no periodic CSI-RS transmission.

The WTRU after predicting L CSI values using the CSI prediction model, may report the L CSI values, using either of the aforementioned methods, e.g., periodic, semi-persistent, aperiodic based reporting. Since the CSI reporting is carried out for L time slots ahead of the current time slot, The BS may not send the CSI-RS until the L time slots are elapsed. The BS may use the L predicted CSI values received from the WTRU in a single PUSCH report, until the L time slot window elapses.

After L time slots, the network (e.g., the network node) may activate the CSI-RS transmission using MAC/CE, where the WTRU estimates the CSI using the received CSI-RS. The estimated CSI samples may be used to fill the historical CSI samples for CSI prediction. During this process, where WTRU may fill the historical CSI buffer, the network (e.g., the network node) may trigger the WTRU to report the legacy CSI, for example, using the same CSI-RS set used for historical CSI buffer. The CSI estimated using conventional/legacy methods may be send to the network (e.g., the network node).

If the WTRU's CSI prediction model has procured enough historical samples in the buffer, the WTRU may send buffer completion flag to the network (e.g., the network node). The network (e.g., the network node) and WTRU may perform the methods described above. Any of the following may be employed:
the WTRU may receive the uplink grant by the network (e.g., the network node) for single shot CSI reporting; and
the WTRU may feedback the L predicted CSI values in a single PUSCH.

This approach may reduce the overhead both in the UL and/or the DL as it dispenses with network transmitting CSI-RS for L time slots.

### Periodic Reporting of CSI Values:

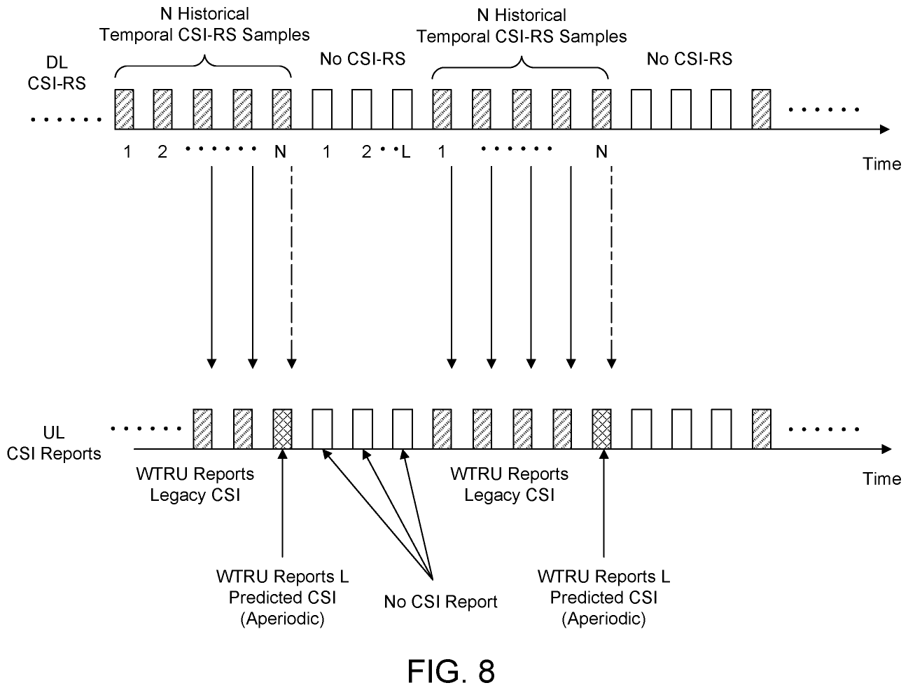

This procedure may also be triggered for periodic CSI reporting by RRC, where the network (e.g., the network node) periodically may send and/or may stop CSI-RS, e.g., send CSI-RS for building the historical CSI values and/or stop sending CSI-RS until L time slots, as shown in FIG. 8, where L is the look-ahead window size of the CSI prediction model.

The periodic CSI reporting may be employed using PUCCH. In this case, the CSI reporting may be implicit, i.e., PMI, RI, LI, CQI.

### Semi-Persistent Reporting of CSI Values:

This procedure may also be employed with semi-persistent reporting, where the semi-persistent is activated/deactivated by MAC CE.

In semi-persistent CSI reporting:
The predicted CSI values may be reported in a single semi-persistently allocated PUSCH:
   The predicted CSI values may be explicit CSI matrices or implicit CSI.
The predicted CSI values may be reported in periodically allocated PUCCH:
   The predicted CSI values may be implicit CSI.

An example timeline for the single-shot (aperiodic) reporting of L predicted CSI samples is shown in FIG. 8, where no CSI-RS are transmitted during the look-ahead window.

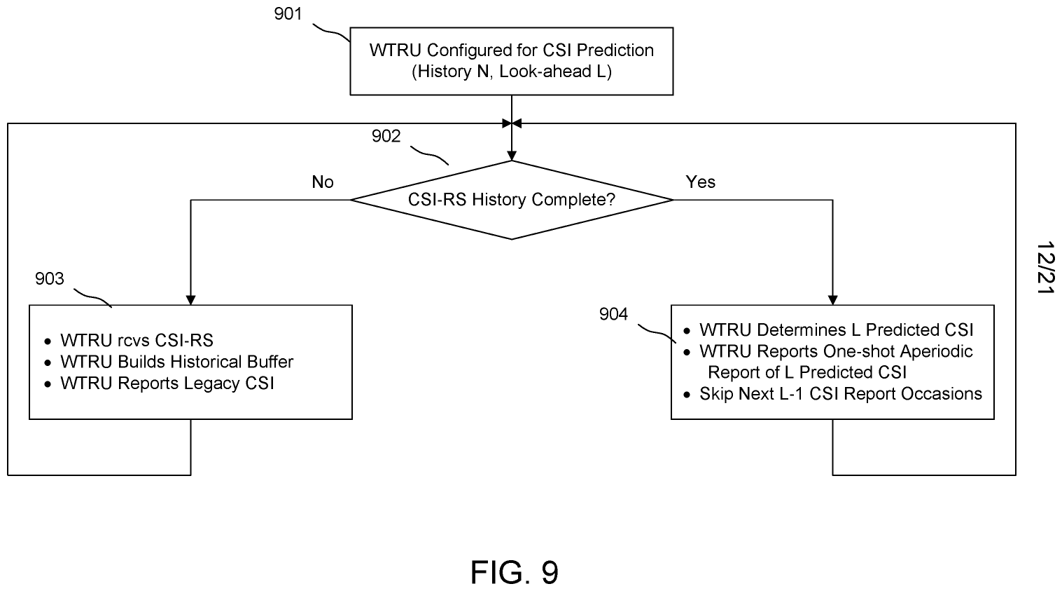

FIG. 9 illustrates a WTRU procedure for reporting of L predicted CSI samples in a single report (CSI-RS overhead reduction).

In a step 901, the WTRU may be configured for CSI prediction (for example with the CSI prediction look-ahead window size L, as well as the number of CSI-RS temporal samples, N, for example, for (e.g., required) for building the CSI history buffer). In a step 902, the WTRU may determine if the CSI history buffer is complete. If the CSI history buffer is not complete, in a step 903, the WTRU may continue to receive CSI-RS temporal samples, build the CSI history buffer, and/or report legacy CSI. If the CSI history buffer is complete, in a step 904, the WTRU may determine L predicted CSI, report one-shot aperiodic report of L predicted CSI, and/or skip next L−1 CSI report occasions.

### Reporting of Single Predicted CSI Value

### [WTRU Procedure to Calculate L Predicted CSI Values and Report Single Samples]

### Semi-Persistent Reporting of Predicted CSI Values:

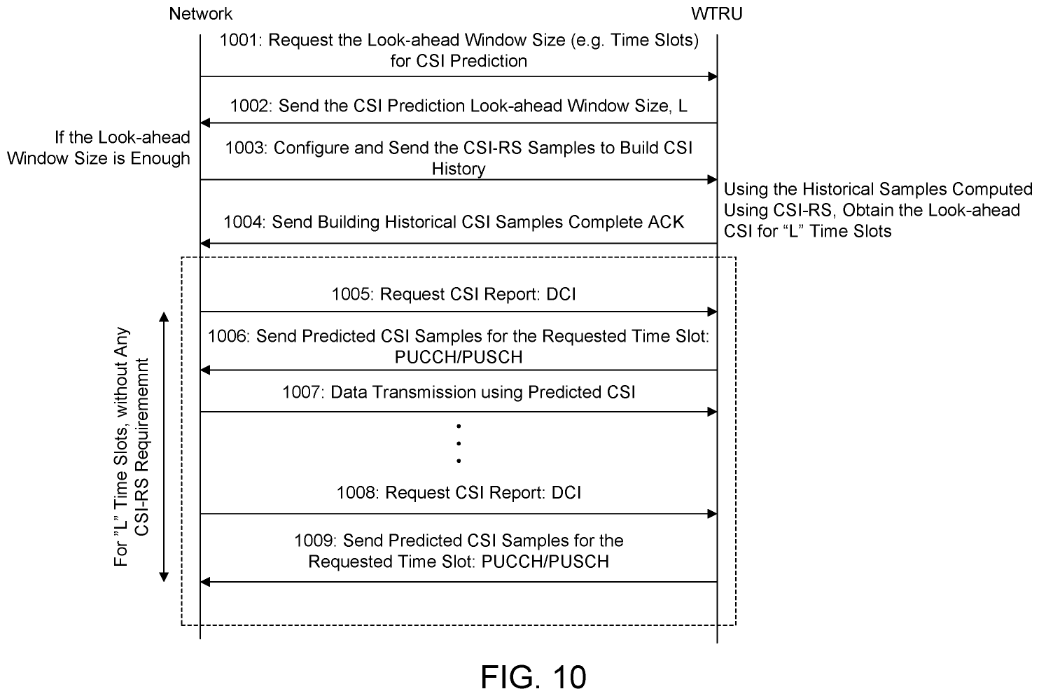

The signaling procedure of semi-persistent reporting of L predicted CSI values is shown in FIG. 10.

According to embodiments, in a step 1001, the WTRU may receive the look-ahead window size request from the network. In a step 1002, the WTRU may transmit to the network (e.g., the network node), the CSI prediction look-ahead window size L, as well as the number of CSI-RS temporal samples, N, for example, for (e.g., required) for building historical CSI:
The CSI prediction look-ahead window size may use (e.g., depend on) the trained CSI prediction model.
The WTRU may report the expected prediction accuracy as a function of the look-ahead (for up to L_max look-ahead).

For example, if the look-ahead window size L is enough, in a step 1003, the network (e.g., the network node) and/or the WTRU may be configured for CSI prediction with L look-ahead window size (L<=L_max). The WTRU may receive the N CSI-RS samples, for example, for building the historical CSI data. The WTRU may report legacy CSI, for example, while building the historical CSI data.

The WTRU relying on the “N” historical CSI samples computed using CSI-RS, may employ RNN based CSI prediction model, where the WTRU may predict “L” CSI samples ahead in time. The WTRU upon predicting the CSI for a look-ahead window size of L, may send an ACK in a step 1004, for example, to the BS, indicating that L CSI predicted samples for the next L transmit opportunities are available.

In a step 1005, the network node/BS based on the transmission requirements (e.g., other scheduled users, resources available, etc.) may trigger WTRU for periodic transmission of the predicted CSI, where the WTRU, in a step 1006, may report the predicted CSI value corresponding to the next transmit opportunity (e.g., only).
The WTRU may report the predicted CSI value for the next transmit opportunity on a periodically allocated PUCCH.
   The predicted CSI value may be implicit CSI.
The WTRU may report the predicted CSI value for next transmit opportunity on a semi-persistently available PUSCH resource.
   The predicted CSI value may be explicit CSI.

In a step 1007, the network (e.g., the network node) may send data using the predicted CSI.

The WTRU may (e.g., continue to) report the predicted CSI for the next transmit opportunity in every subsequent PUCCH/PUSCH, for example, until the WTRU reported the L predicted CSI values for L transmit opportunities, in step 1008 and 1009, as shown in FIG. 10:
The WTRU may report L predicted CSI values on L PUCCH/PUSCH, i.e., in every PUCCH/PUSCH the WTRU may report predicted CSI value that is pertinent (e.g., only) to the immediate transmit opportunity.
Unlike the single shot reporting of predicted CSI where L predicted CSI values are reported in a single PUCCH/PUSCH—this approach may consider reporting the predicted CSI in every subsequent PUCCH/PUSCH, where the network (e.g., the network node) may request the WTRU to report CSI.
This procedure may be use when the size of PUCCH/PUSCH is limited.

As discussed above, the CSI-RS can still be periodic transmission, while the CSI reporting may be semi-persistent as shown in FIG. 10. The rationale for having periodic CSI-RS transmission may be to build the RNN buffer for historical CSI samples, which may be periodically updated using the periodic CSI-RS transmissions.

### Periodic Reporting of L Predicted CSI Values:

The WTRU upon predicting the CSI for a look-ahead window size of L using the historical CSI samples, the WTRU may report the predicted CSI sample pertaining to the immediate transmit opportunity on the periodically available PUCCH.
In periodic reporting on PUCCH, the predicted CSI values may be implicit, that is PMI, RI, CQI, LI. This is because of the limited capacity of PUCCH, and hence may not be feasible for larger reporting payloads such as full CSI matrix.

In this option, both CSI-RS and CSI reporting may be periodic.

### Aperiodic Reporting of L Predicted CSI Values:

The WTRU upon predicting the CSI for a look-ahead window size of L, the WTRU may send an ACK, for example, to the network node (e.g., BS) indicating that L CSI predicted samples for the next L transmit opportunities are available. The network node (e.g., BS) based on the transmission requirements (e.g., other scheduled users, resources available, etc.) may trigger WTRU by DCI for predicted CSI pertaining to a specific slot from the L predicted CSI values.

The WTRU may report the predicted CSI value corresponding to the slot requested, for example, using the PUSCH.

The signal flow for the periodic reporting of the predicted CSI for any (e.g., each) CSI reporting opportunity (e.g., periodic predicted CSI reporting) is shown in FIG. 10.

### Look-Ahead Window: Adaptive Framework

The WTRU may employ an adaptive look-ahead window framework for reporting the next predicted CSI samples. In this context, after the L time slots elapses following a WTRU reporting of a predicted CSI, the WTRU may send a new look-ahead window size and a new predicted CSI samples size.

According to embodiments, the WTRU may be configured to use a different look-ahead window size and/or a different number of future samples each time it reports the predicted CSI. The WTRU may decide to switch to a smaller or larger value of “L” based on a specific event. For example, the WTRU may assess the prediction accuracy for samples obtained from the latest “N” historical CSI buffer, then decide to increase or decrease the look-ahead window size and the number of predicted CSI samples. According to embodiments, the WTRU may rely on a preconfigured threshold to change “L” then report the difference in the size of the window “AL” (AL may be a positive or a negative number) and the predicted “L+ΔL” CSI samples to the network (e.g., the network node).

WTRU Procedures with Periodic CSI-RS:

According to embodiments, the adaptive L and predicted CSI sample may be applied to the case where the WTRU keeps receiving CSI-RS during the look ahead window.

The WTRU relying on the “N” historical CSI samples computed using CSI-RS, may employ RNN based CSI prediction model, where the WTRU may predict “L” CSI samples ahead in time. The WTRU upon predicting the CSI for a look-ahead window size of L, the WTRU may send an acknowledgement (ACK) to the network node (e.g., BS) indicating that L CSI predicted samples are available. The network node (e.g., BS) based on the transmission requirements (e.g., other scheduled users, resources available, etc.) may send the uplink grant to the WTRU for CSI reporting, for example, via downlink control information (DCI).

The WTRU based on historical CSI samples computed using CSI-RS and the accuracy of the previous predictions, may compute a new value for L.

The WTRU after receiving the uplink grant via DCI, may report the L predicted CSI values, for example, in a single PUSCH together with the new value of L. The WTRU may report ΔL=L−Lnew to reduce the overhead of uplink signaling.

Prior to sending next predicted CSI samples, the network node (e.g., BS) may allocate uplink resources for the reporting of L′=L+ΔL CSI samples. In the next CSI reporting cycle, the WTRU may report L′ CSI samples, for example, together with the update on L′.

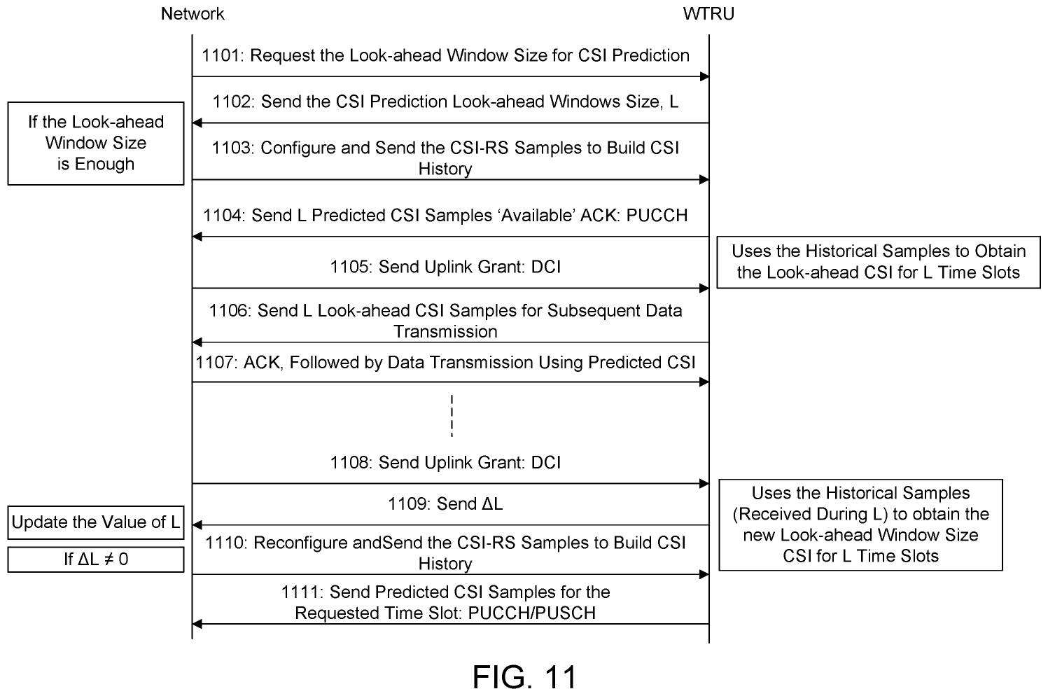

The signaling procedure of aperiodic report of L predicted CSI values and the update on the value of L is shown in FIG. 11.

According to embodiments, in a step 1101, the WTRU may receive the look-ahead window size request from the network (e.g., the network node). In a step 1102, the WTRU may transmit to the network (e.g., the network node), the CSI prediction look-ahead window size L, as well as the number of CSI-RS temporal samples, N, for example, for (e.g., required) for building historical CSI:
The CSI prediction look-ahead window size may use (e.g., depend on) the trained CSI prediction model.
The WTRU may report the expected prediction accuracy as a function of the look-ahead (for up to L_max look-ahead).

For example, if the look-ahead window size L is enough, in a step 1103, the network (e.g., the network node) and/or the WTRU may be configured for CSI prediction with L look-ahead window size (L<=L_max). The WTRU may receive the N CSI-RS samples, for example, for building the historical CSI data. The WTRU may report legacy CSI, for example, while building the historical CSI data.

The WTRU relying on the “N” historical CSI samples computed using CSI-RS, employs RNN based CSI prediction model, where the WTRU may predict “L” CSI samples ahead in time. The WTRU upon predicting the CSI for a look-ahead window size of L, the WTRU may send an acknowledgement (ACK) to the network node (e.g., BS) indicating that L CSI predicted samples are available in a step 1104.

The network node (e.g., BS) based on the transmission requirements (e.g., other scheduled users, resources available, etc.) may send the uplink grant to the WTRU for CSI reporting via downlink control information (DCI) in a step 1105.

In a step 1106, the WTRU after receiving the uplink grant via DCI, may report the L predicted CSI values, for example, in a single PUCCH/PUSCH.

In a step 1107, the network (e.g., the network node) may send an ACK to the WTRU, followed by data transmission using the predicted CSI for L look-ahead slots.

In a next CSI reporting cycle, the WTRU after receiving the uplink grant via DCI in a step 1108, may report the L predicted CSI values in a single PUSCH, for example together, with the new value of L.

In a step 1109, the WTRU may report ΔL=L−Lnew to the network node to reduce the overhead of uplink signaling.

In a step 1110, the network node may update the value of L, and reconfigure the WTRU to receive the CSI-RS samples, for example, for building the historical CSI data.

In a step 1111, the WTRU after receiving the uplink grant via DCI, may report the new L predicted CSI values, for example, in a single PUCCH/PUSCH.

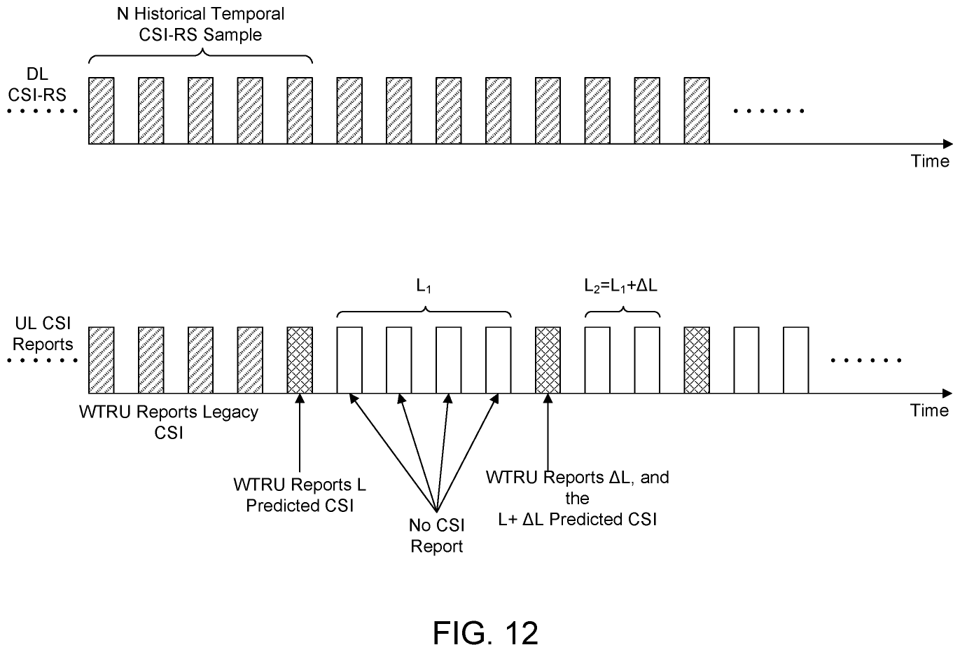

An example timeline for the single-shot (aperiodic) reporting of L predicted CSI samples is shown in FIG. 12, where it shows that the window size “L1” has been updated in the second cycle to “L2=L1+ΔL” using ΔL, hence the number of predicted CSI samples has changed.

WTRU Procedures with No CSI-RS:

According to embodiments, the network node (e.g., BS) may not send any CSI-RS during the look-ahead window, which is activated right after it elapses. In this case, after the “L” window elapses the network (e.g., the network node) resumes CSI-RS transmission and the WTRU may use the received CSI-RS to report legacy CSI while filling the historical CSI buffer. Relying on the newly received CSI-RS, the WTRU may compute “N” historical CSI samples, and may predict the CSI samples for the next look-ahead window. The WTRU may decide to update “L” as any of the following actions:
After the window “L” elapses, the WTRU starts building a new historical CSI buffer in order to obtain the predicted CSI samples.
Based on the historical CSI samples computed and the accuracy of the previous predictions, computes a new value for L.

The WTRU after receiving the uplink grant via DCI, reports the L predicted CSI values in a single PUSCH together with the new value of L. The WTRU may report ΔL=L−Lnew to reduce the overhead of uplink signaling.

Prior to sending next predicted CSI samples, the network node (e.g., BS) allocates uplink resources for the reporting of L′=L+ΔL CSI samples. In the next CSI reporting cycle, WTRU reports L′ CSI samples together with the update on L′.

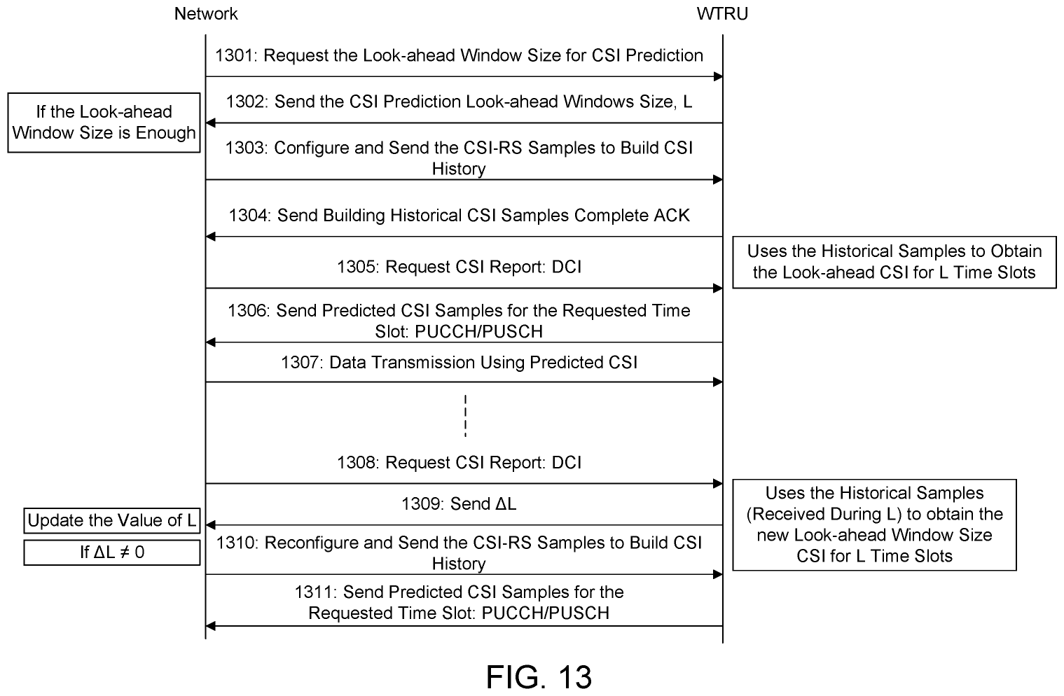

The signaling procedure of aperiodic report of L predicted CSI values and the update on the value of L is shown in FIG. 13.

According to embodiments, in a step 1301, the WTRU may receive the look-ahead window size request from the network (e.g., the network node).

In a step 1302, the WTRU may transmit to the network (e.g., the network node), the CSI prediction look-ahead window size L, as well as the number of CSI-RS temporal samples, N, for example, for (e.g., required) for building historical CSI:
The CSI prediction look-ahead window size may use (e.g., depend on) the trained CSI prediction model.
The WTRU may report the expected prediction accuracy as a function of the look-ahead (for up to L_max look-ahead).

For example, if the look-ahead window size L is enough, in a step 1303, the network (e.g., the network node) and/or the WTRU may be configured for CSI prediction with L look-ahead window size (L<=L_max). The network node (e.g., BS) may not send any CSI-RS during the look-ahead window, which is activated right after it elapses. In this case, after the “L” window elapses the network (e.g., the network node) may resume CSI-RS transmission and the WTRU may use the received CSI-RS to report legacy CSI while filling the historical CSI buffer.

The WTRU relying on the “N” historical CSI samples computed using CSI-RS, employs RNN based CSI prediction model, where the WTRU may predict “L” CSI samples ahead in time. The WTRU upon predicting the CSI for a look-ahead window size of L, the WTRU may send an acknowledgement (ACK) to the network node (e.g., BS) indicating that L CSI predicted samples are available in a step 1304.

The network node (e.g., BS) based on the transmission requirements (e.g., other scheduled users, resources available, etc.) may send a request to the WTRU for CSI reporting via downlink control information (DCI) in a step 1305.

In a step 1306, the WTRU after receiving the request via DCI, may report the L predicted CSI values, for example, in a single PUSCH.

In a step 1307, the network (e.g., the network node) may send to the WTRU data using the predicted CSI for L look-ahead slots.

The WTRU may decide to update “L” as any of the following actions:
After the window “L” elapses, the WTRU starts building a new historical CSI buffer in order to obtain the predicted CSI samples.
Based on the historical CSI samples computed and the accuracy of the previous predictions, computes a new value for L.

In a step 1308, the network node may request a CSI report, for example, via DCI.

In a step 1309, the WTRU may report ΔL=L−Lnew to reduce the overhead of uplink signaling.

In a step 1310, the network node may update the value of L, and reconfigure the WTRU to receive the CSI-RS samples, for example, for building the historical CSI data.

In a step 1311, the WTRU after receiving the uplink grant via DCI, may report the new L predicted CSI values, for example, in a single PUCCH/PUSCH.

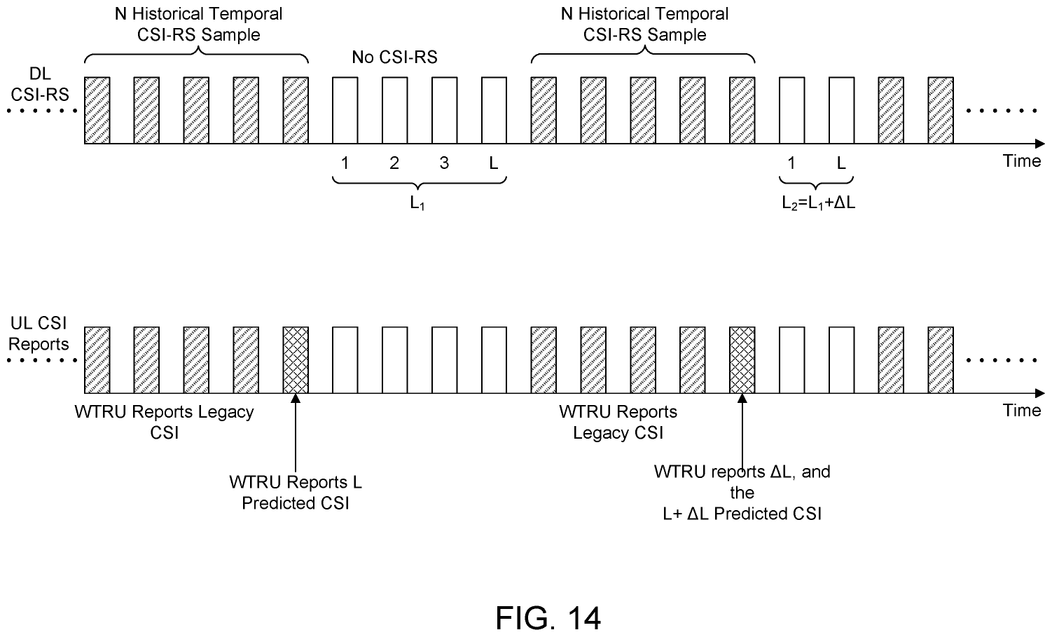

An example timeline for the single-shot reporting of L predicted CSI samples is shown in FIG. 14, where it shows that the window size “L1” has been updated in the second cycle to “L2=L1+AL” using ΔL based in the newly computed historical CSI samples.

### Representative CSI Prediction Performance Metrics

### WTRU Measurements for CSI Prediction Performance

### [WTRU Performance Metrics During the CSI Prediction Stage]

The WTRU may perform additional channel measurements, for e.g., channel coherence time, channel coherence bandwidth, SNR, Doppler spread, etc. Changes in the measured channel conditions may trigger the WTRU to assess the performance of the CSI prediction during the prediction stage. In an embodiment, if the WTRU measures a change in the channel coherence time, it may send an indication to the network node/BS (e.g., eNB, gNB) to report the change. The WTRU may be configured to report the channel coherence time periodically and/or when prompted by the network node/BS (e.g., eNB, gNB) (e.g., via DCI) and/or when it exceeds a corresponding pre-configured threshold. An increase in the channel coherence time may signify the channel changing from a fast-fading to a slow-fading channel. As a result, the WTRU may increase the size of the look-ahead window to accommodate a larger number of time slots for prediction. In an embodiment, a small value of the coherence time (i.e., below a preconfigured threshold set by either WTRU or BS (e.g., eNB, gNB)) may be indicative of a fast-fading channel, implicitly indicating to the WTRU that measurements of additional metrics (e.g., SNR) may be required. The WTRU may report the additional measurements to the BS (e.g., eNB, gNB) as standalone or by including them as part of the CSI feedback report (e.g., CQI, SNR, etc.).

ACK/NACK statistics measured by the WTRU may be indicative of the performance of the ML-based decoder for CSI prediction. For example, if the WTRU sends several consecutive NACKs to the BS (e.g., eNB, gNB), the BS (e.g., eNB, gNB) may send a request to the WTRU to re-assess the performance of the CSI prediction model. The number of consecutive NACKS that would trigger a re-assessment of the CSI prediction model may be configured by the BS (e.g., eNB, gNB). The BS (e.g., eNB, gNB) may send a request for training/retraining of the ML model at the WTRU.

The WTRU may decide to measure and keep track of ACK/NACK statistics over a time window. If the number/percentage of NACK responses recorded over that window exceeds a pre-configured threshold, the WTRU may re-assess the performance of the CSI prediction, e.g., through computation of the NMSE or cosine similarity.

### CSI Prediction Error Stage During the CSI Testing/Calibration Stage (Aperiodic Test CSI-RS Signals Transmitted)

The WTRU may use the traditional CHEST reporting framework as a reference to assess the output of the ML model and/or calibrate/re-calibrate the neural network. The WTRU may compute the difference/discrepancy/error between the output of the CSI prediction model and the result of the traditional CHEST reporting framework. The difference/discrepancy/error may be computed either through any of:

### (i) NMSE

The Normalized Mean Squared Error may be used as the performance assessment of the ML model whereby the accuracy of the ML model may be inversely proportional to the NMSE value computed at the WTRU. The WTRU may quantify the normalized MSE (NMSE) as shown in the Equation below:

$$NMSE = E ( \frac{{‖ H - \hat{H} ‖}_{2}^{2}}{{‖ H ‖}_{2}^{2}} ) ,$$

with H: CSI channel matrix from traditional channel estimation; and Ĥ: Output of ML enabled decoder.

### (ii) Cosine Similarity

The Cosine similarity measures the similarity between the reference channel matrix and the output of the ML decoder. The WTRU may compute the cosine similarity ρ as shown in the Equation below:

$$ρ = E \{ \frac{1}{{N}_{c}} {\sum }_{n = 1}^{{N}_{c}} \frac{\vert {h}_{n} {\tilde{h}}_{n}^{H} \vert}{{‖ {h}_{n} ‖}_{2} {‖ {\tilde{h}}_{n} ‖}_{2}} \} ,$$

with \tilde{h}ₙ: reconstructed channel vector at the nth subcarrier at the output of the ML decoder.

The NMSE or Cosine similarity may be used to quantify the recovery performance. The quantified result of the difference/discrepancy/error which may be computed by the WTRU may be assessed against a pre-configured threshold. In an embodiment, if NMSE computed by the WTRU<Threshold T1, the WTRU may report to the BS (e.g., eNB, gNB) that the performance of the CSI model predictor is adequate and/or the WTRU may not trigger re-measurements/re-computation of the NMSE, for e.g., for a certain time period.

Similarly, if in an embodiment, the cosine similarity computed by the WTRU, ρ, is above a pre-configured threshold, the WTRU may report to the BS (e.g., eNB, gNB) that the performance of the CSI model predictor is good and the WTRU may not trigger re-computation of ρ for a certain sub-carrier for a certain time period. Conversely, if the cosine similarity computed by the WTRU, ρ, is below a certain threshold, the WTRU may report the value of the cosine similarity to the BS (e.g., eNB, gNB) who may send a request for re-training of the model or the WTRU may trigger re-measurements of the cosine similarity. The aforementioned thresholds may be pre-configured, for example, by the WTRU and/or indicated to/approved by the BS (e.g., eNB, gNB). The threshold may (e.g., alternatively) be configured by the BS (e.g., eNB, gNB) and/or shared with the WTRU during initial configuration (e.g., during RRC).

The WTRU may perform additional channel measurements, for e.g., channel coherence time, channel coherence bandwidth, SNR, Doppler spread, etc. Changes in measured channel conditions may trigger changes in the thresholds. In an embodiment, if the WTRU measures a decrease in the channel coherence time, it may report the change to the BS (e.g., eNB, gNB). The BS (e.g., eNB, gNB) may trigger a change in the pre-configured threshold(s) to accommodate the dynamic change in channel conditions.

The measurement of the NMSE or Cosine similarity may be a function of the prediction instant in the look-ahead window. For example, the error/discrepancy/difference computed at time instant L+1 may be smaller than the error/discrepancy/difference computed at time instant L+n (where n>>1). As a result, the threshold value(s) may also be a function of the function of the time instant in the look-ahead window.

There may be multiple thresholds (e.g., T1, T2, T3, . . . , TN) configured by the BS (e.g., eNB, gNB) for the measurement of one performance metric. E.g., the BS (e.g., eNB, gNB) may configure one or more threshold values which when exceeded may trigger the WTRU to compute the NMSE between the traditional channel estimation and the output of the ML decoder. Any of the (e.g., each) threshold values may be associated to specific parameters and/or the WTRU may decide the threshold to use depending on its measurement of the parameter. In an embodiment, one threshold (e.g., T1) may correspond to a certain SNR range such that if the SNR goes outside of the range, the WTRU may have to use a different threshold (e.g., T2) corresponding to the new measured SNR. The error/discrepancy/difference (e.g., NMSE or cosine similarity) exceeding a final threshold TN may trigger the WTRU to re-train the ML prediction model.

### Trigger for Re-Training the AI/ML CSI Prediction Model

The WTRU may start a counter/timer, for example, when (e.g., every time) it completes the training of the CSI prediction model. Expiry of the counter/timer may trigger the WTRU to re-train the model. The length of time set by the timer may be measured/recorded in any of the following units: time slots, symbol duration, SFN and seconds/milliseconds. The counter may be measured in number of symbols. The length of the timer/counter may be pre-configured by the WTRU and indicated to the BS (e.g., eNB, gNB), or vice-versa. The BS (e.g., eNB, gNB) may send a message to the WTRU to request for a change in the length of the counter/timer. In an embodiment, the BS (e.g., eNB, gNB) may register poor uplink channel conditions from CSI reports from the WTRU. The BS (e.g., eNB, gNB) may send a request to the WTRU to decrease the length of the timer/counter trigger the.

For example, at the start of the session, the BS (e.g., eNB, gNB) may send a request to the ML-capable WTRU to report its time-domain CSI prediction capability. In response, the WTRU may report the length of the look-ahead window (LA) and/or the length of the maximum look-ahead window (LAmax), for example, in terms of the number of time slots. The BS (e.g., eNB, gNB) may have a target length for CSI-predictability expected from ML-capable WTRUs. In the event that LA or LAmax may be less than the target number of time slots for prediction, the BS (e.g., eNB, gNB) may trigger online training/re-training of the CSI prediction model at the WTRU.

In cases where computation of the error as described above may exceed pre-configured thresholds, the WTRU may trigger re-training of the ML model. For example, if NMSE>Threshold T1 and/or if Cosine similarity<Threshold T2, the WTRU may trigger training/re-training of the ML model. The BS (e.g., eNB, gNB) may also have thresholds corresponding to the performance metrics of the ML-capable WTRUs. If the WTRU reports the computed NMSE and/or Cosine similarity to the BS (e.g., eNB, gNB), and the error performance metrics are below the corresponding thresholds at the BS (e.g., eNB, gNB), the BS (e.g., eNB, gNB) may send an indication to the WTRU to trigger training/re-training of the CSI prediction model.

The WTRU may perform additional channel measurements, for e.g., channel coherence time, channel coherence bandwidth, SNR, Doppler spread, BLER, etc. Changes in measured channel conditions may trigger training/re-training of the ML model at the WTRU. In an embodiment, if the WTRU records/measures a change in the channel coherence time such that the channel coherence time is smaller than the length of the look-ahead window, the WTRU may need to trigger training/re-training of the CSI prediction model and send an indication to the BS (e.g., eNB, gNB) to inform the BS (e.g., eNB, gNB) of the training/re-training of the ML model and/or any changes in the look-ahead window as a result of the change in channel conditions.

The WTRU may report the change in the channel coherence time to the BS (e.g., eNB, gNB). With the knowledge of the size of the look-ahead window, the BS (e.g., eNB, gNB) may send a message to the WTRU to trigger training/re-training of the CSI prediction model. The WTRU may be configured to report the channel coherence time periodically to the BS (e.g., eNB, gNB) or when prompted by the BS (e.g., eNB, gNB) through an indication sent to the WTRU (e.g., in DCI). There may also be a semi-periodic configuration whereby the WTRU reports the channel coherence time to the BS (e.g., eNB, gNB) with a periodicity set by the BS (e.g., eNB, gNB) as well as when prompted by the BS (e.g., eNB, gNB) and/or when the WTRU measures a large change in the channel coherence time. In an embodiment, there may be configuration of a channel coherence time threshold at the WTRU. Exceeding of the channel coherence time threshold may trigger reporting of the coherence time to the BS (e.g., eNB, gNB). Thresholds for other channel measurements may also be configured. In an embodiment, if the SNR measured by the WTRU is below the corresponding pre-configured threshold and/or the BLER is above a corresponding pre-configured threshold, the WTRU may trigger training/re-training of the CSI prediction model.

### Representative Update the Predicted CSI (Upon Detection of Prediction Error Events)

### RS Configuration for Prediction and for Prediction Error Detection

A WTRU may be configured with a first set of RSs (e.g., CSI-RS) on which to perform channel estimation and prediction for up to L slots. The first set of RSs may have a high density and short periodicity. The first set of RSs may be bursty or semi-persistent. For example, the first set of RSs may be received by the WTRU for a period of time (i.e., a burst) upon conclusion of the period of time or burst, the WTRU may no longer expect the RS to be transmitted until a future burst.

A WTRU may be configured with a second set of RSs on which to perform channel estimation and comparison with predicted (e.g., previously predicted) CSI reports. The second set of RSs may be configured to be periodic. The second set of RSs may have a longer periodicity than the first set of RSs. In an embodiment, the WTRU may only expect to receive the second set of RSs outside of the burst of the first set of RSs.

In an embodiment, the second set of RSs may be a subset of the first set of RSs. For example, a first set of RSs may include n RSs, each with a different offset and same or different periodicity. The second set of RSs may be a subset m, where msn, of the RSs in the first set. The start time and duration of a burst of the first set of RSs may be fixed or configurable by RRC or DCI or MAC CE. The WTRU may determine the time and duration of a burst of the first set of RSs by any of the following:
Semi-static configuration. For example, the start time and duration of the bursts may be periodic. The WTRU may receive the configuration via RRC.
Dynamic indication. For example, a WTRU may receive a dynamic indication via DCI or MAC CE indicating an upcoming burst start time and/or duration.
Burst start time or duration or end time of a previous burst. For example, a WTRU may expect a burst of a first set of RSs if the time since a previous burst is greater than a configurable value. The time between bursts may be determined from the number of slots of predicted CSI transmitted by a WTRU.
The number or timing of predicted slots (L).
WTRU request. For example, a WTRU may transmit a request for a burst of the first set of RSs. The WTRU may receive a confirmation that the burst is transmitted, e.g., via DCI or MAC CE.

Based on measurements performed on at least one RS of the first set of RSs, the WTRU may determine up to L predicted CSI values. The WTRU may report L CSI values in a CSI feedback report on a CSI feedback resource. The predicted CSI feedback report may include the complete CSI values for each L predicted value or may include a first complete report for a first reference slot and differential or delta CSI values for the other L−1 slots.

The WTRU may transmit a single CSI report, or a single set of CSI reports applicable for the L predicted slots. The CSI report(s) may include CSI values along with the number and identity of the L slots for which the predicted CSI is valid. For example, each CSI value may be associated to a reference slot. The timing or identity of a slot for which a predicted value is applicable may be determined by any of the following:
Codebook used for feeding back predicted values. For example, each position in the CSI feedback codebook may be associated with a slot timing or identity.
Feedback resource. For example, the timing or identity of at least one associated slot may be determined by a parameter of the feedback resource used to feedback the predicted values. The parameters may include at least one of: timing of the feedback resource, resource type, frequency resource allocation, Orthogonal cover code, CS index.
Timing and duration and resources of at least one RS of the first set of RSs.
Higher layer configuration.

A WTRU may transmit CSI reports associated to at least one RS in the second set of RSs. For example, a WTRU may report a set of predicted CSI values based on measurements obtained on at least one RS of the first set of RSs. The WTRU may, or may additionally, report CSI values based on measurements obtained on at least one RS of the second set of RSs. The two types of CSI reports may be reported in different resources with different resource configuration. The types of CSI reports for each CSI report may differ. The report of predicted CSI values or the report of CSI values may include any of the following: RI, PMI, CQI, CRI, SSBRI, LI, L1-RSRP, coherence time, coherence BW, and doppler spread.

For example, a first CSI report of predicted CSI values may include a set of RI/PMI/CQI for each slot in the set of L slots. A second CSI report may include an updated CQI value and a coherence time. The coherence time may be used to determine the validity of previously predicted CSI values. In an embodiment, a WTRU may report a correlation coefficient in a second CSI report. The correlation coefficient may be obtained by using the predicted CSI value of a reference slot and the actual CSI value of the reference slot.

### Error Detection

The WTRU may perform CSI measurements on at least one RS of the second set of RSs. At least one resource of one RS of the second set of RSs may be associated to a reference slot of at least one predicted CSI value.

The WTRU may compare the CSI measurement on the at least one RS of the second set of RSs to a predicted CSI value determined for a reference slot associated to the at least one RS of the second set of RSs. The WTRU may determine the prediction error (e.g., the NMSE between the measured value and the predicted value).

A WTRU may be configured or signaled a set of error detection threshold. The WTRU may compare the prediction error of at least one predicted CSI to at least one threshold.

The WTRU may determine at least one error detection threshold as a function of any of the following:
Configuration. For example, the error detection threshold may be fixed.
HARQ-ACK feedback. For example, the threshold may be determined as a function of the percentage of NACKs for transmissions. The set of transmissions on which the percentage may be determined may be based on a moving window of fixed size.
Priority of the transmissions. For example, the threshold may depend on the PHY layer priority of at least one associated transmission.
BLER requirements. For example, the threshold may be determined as a function of the required BLER of an associated transmission.
Number of predicted CSI values (L).
Measured or predicted CSI value. For example, a threshold may be determined as a percentage difference from a measured of predicted value.

If the prediction error is greater than a threshold, the WTRU may determine there is a prediction error event for the associated reference slot.

### WTRU Behaviour Upon Detecting Prediction Error

The WTRU may be configured with a set of thresholds and depending on the thresholds for which a predicted error is greater than, the WTRU may have different behaviours.

If a WTRU determines that the prediction error is greater than a first threshold, the WTRU may add 1 to a counter. The WTRU may be configured with a maximum counter value. The WTRU may be configured with a counter timer. When the counter value is greater than the maximum counter value, the WTRU may determine a prediction error event and may perform one of the behaviours listed below. When the timer is expired, the WTRU may determine a prediction error event and may perform one of the behaviours listed below. The WTRU may reset the counter when the timer expires. The WTRU may reset the counter or timer after transmitting a CSI report or a set of predicted CSI values. The WTRU may restart the timer when it increments the counter.

If a WTRU determines that the prediction error is greater than a second threshold, the WTRU may determine a prediction error event and may perform one of the behaviours listed below.

Upon determining or detecting a prediction error event, the WTRU may perform any of the following behaviours:
Report an indication of a prediction error event. For example, the WTRU may report at least one of: the value of the prediction error, the number of slots in error, the identity of the slots in error. The indication may be in UCI or in a MAC CE.
Report the prediction error for one or more slots.
Report a new set of predicted values. For example, the WTRU may report a new predicted value for the associated reference slot on which an error event was determined. In another example, the WTRU may report new predicted values for a new set of L slots. In another example, a WTRU may report new predicted values for the remaining slots in the original set of L slots.
Report error correction values. For example, the WTRU may report an error correction value that may be used in combination with the previously transmitted predicted CSI value to obtain the corrected CSI value. The WTRU may report error correction values for one, some, or all remaining slots in the original set of L slots for which the WTRU previously reported predicted CSI.
Report a new CSI value for the reference slot and cancel or invalidate all previously reported predicted CSI value for the remainder of the original set of L slots.
Fallback to non-predictive CSI reporting.
Request a set of RSs to determine a new set of predicted CSI values. For example, the WTRU may request the transmission of at least one RS in the first set of RSs. A WTRU may request an update to at least one parameter of the at least one RS in the first set of RSs. For example, the WTRU may request a new burst duration or periodicity.
Request a set of RSs to retrain the AI/ML model. For example, the WTRU may request the transmission of at least one RS in the first set of RSs.
Request resources to retrain an AI/ML model.
Request a new AI/ML model.
Report CSI measurements to enable a reconfiguration of the first or second set of RSs.
Report a new desired value of predicted set L.
Transmit an indication on a HARQ-ACK transmission.

### Resource Selection to Indicate Error Event Detected

A WTRU may be configured with resources on which it may transmit a signal, as described above, upon determining a prediction error event.

The WTRU may be configured with conditional grants to transmit the error event indication or UCI.

The WTRU may be configured with PUCCH on which to transmit the error event indication or UCI. For example, the WTRU may be configured with conditional PUCCH that may be used in the event an error event has been detected.

A WTRU may transmit an SR to indicate an error event has occurred. The SR may request resources on which to transmit new or updated CSI values or predicted CSI values. The SR may request the transmission of at least one RS from the first set of RSs.

A WTRU may transmit an RRC message indicating an error. An RRC message may indicate a new desired value of L.

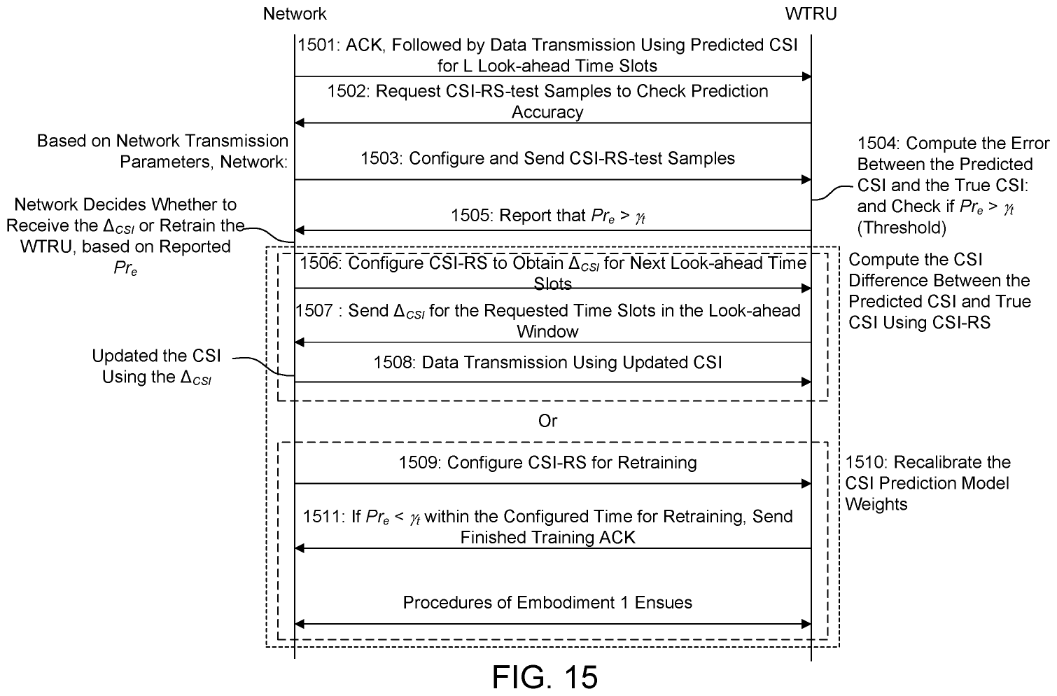

The signal flow for the procedure is illustrated in FIG. 15. In the Figure, the WTRU requests at least one RS from the second set of RSs in order to determine the prediction accuracy. In the Figure, the WTRU may report the difference between the predicted CSI values and the actual CSI values, in the form of a delta_CSI value. In an embodiment, the Figure also shows that a WTRU may be configured to retrain the AI/ML model.

According to embodiments, in a step 1501, the network (e.g., the network node) may send an ACK to the WTRU, followed by data transmission using the predicted CSI for L look-ahead slots. In a step 1502, the WTRU may request to the network (e.g., the network node) CSI-RS test samples to check prediction accuracy. In a step 1503, for example based on network transmission parameters, the network (e.g., the network node) may configure the WTRU for CSI-RS test samples and/or send the CSI-RS test samples to the WTRU. In a step 1504, the WTRU may compute the error between the predicted CSI and the true CSI and check if the error is superior to a threshold. In a step 1505, the WTRU may report the computed error, for example, if the error is superior to a threshold. The network (e.g., the network node) may decide whether to receive the CSI difference or to retrain the WTRU, based on the reported error.

If the network (e.g., the network node) decides to receive the CSI differential, in a step 1506, the network (e.g., the network node) may configure the WTRU for CSI-RS to obtain the CSI difference for next look-ahead time slots. In a step 1507, the WTRU may compute the CSI difference between the predicted CSI and true CSI using CSI-RS, and send the CSI difference for the requested time slots in the look-ahead window. In a step 1508, the network (e.g., the network node) may transmit data using an updated CSI, wherein the updated CSI is obtained based on the CSI difference.

If the network (e.g., the network node) decides to retrain the WTRU, based on the reported error, in a step 1509, the network (e.g., the network node) may configure the WTRU for CSI-RS for retraining. In a step 1510, the WTRU may recalibrate the CSI prediction model weights. In a step 1511, if the error between the predicted CSI and the true CSI is inferior to a threshold within the configured time for retraining, the WTRU may send finished training ack.

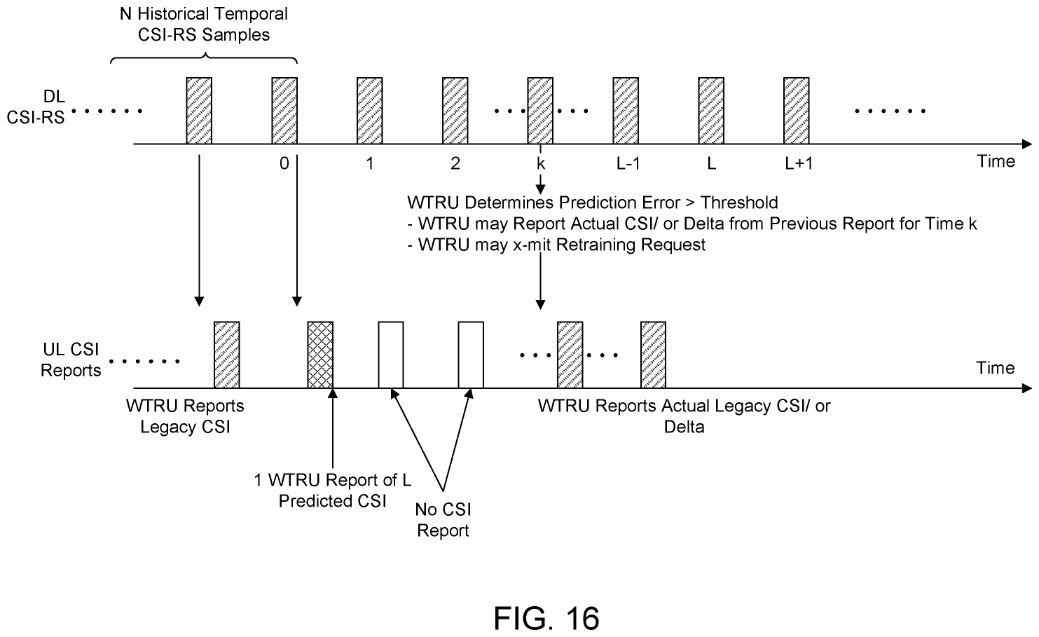

An example timeline for the WTRU determining the prediction error event is shown in FIG. 16, where periodic CSI-RS transmission is assumed. In this Figure, the CSI-RS samples up to 0 are used by the WTRU to determine and report predicted CSI values for slots 0, 1, 2, . . . , L. The WTRU may continue receiving CSI-RSs in slots 1, 2, . . . . Such CSI-RS may be from a second set of RSs. At time k, the WTRU may determine that a prediction error event has occurred due to the error being greater than a threshold. In such a case, the WTRU may report the actual CSI value for slot k. The WTRU may also revert to reporting actual CSI values for the remaining slots up to slot L. Furthermore, the WTRU may request to be retrained and may indicate such in a CSI report.

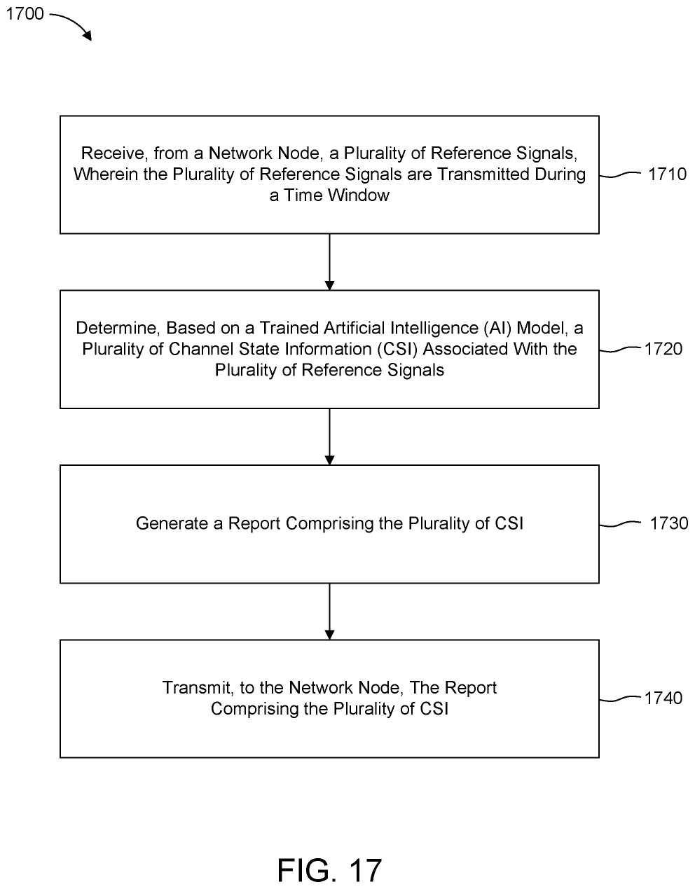

FIG. 17 illustrates an example of a method 1700 for CSI prediction for a wireless system, implemented by a WTRU 102.

According to embodiments, the WTRU 102 may be configured to receive, from a network node (e.g., BS), a plurality of reference signals, wherein the plurality of reference signals is transmitted during a time window (1710).

According to embodiments, the WTRU 102 may be configured to determine, based on a trained AI/ML model, a plurality of CSI associated with the plurality of reference signals (1720).

According to embodiments, the WTRU 102 may be configured to generate a report comprising the plurality of CSI (1730).

According to embodiments, the WTRU 102 may be configured to transmit, to the network node, the report comprising the plurality of CSI (1740).

According to embodiments, the report is transmitted after an ending time of the time window.

According to embodiments, the WTRU 102 may be configured to transmit, to the network node, an information indicating that the plurality of CSI is determined.

According to embodiments, the WTRU 102 may be configured to transmit, to the network node, the report comprising the plurality of CSI in a single transmission.

According to embodiments, the report is transmitted on a physical uplink shared channel (PUSCH).

According to embodiments, the WTRU 102 may be configured to receive from the network node, an uplink grant via a downlink control information (DCI).

According to embodiments, the WTRU 102 may be configured to send, to the network node, a size (e.g., as a length of time) of the time window, and/or a number of the plurality of reference signals.

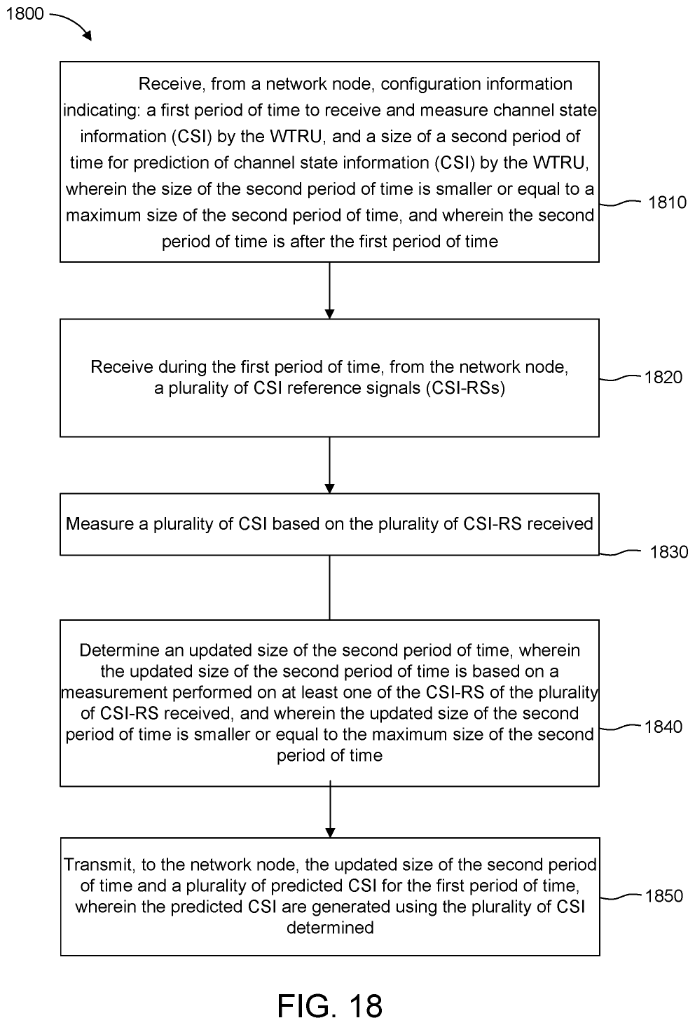

FIG. 18 illustrates another example of a method 1800 for CSI prediction for a wireless system, implemented by a WTRU 102.

According to embodiments, the WTRU 102 may be configured receive, from a network node, configuration information indicating: a first period of time to receive and measure CSI by the WTRU and a size (e.g., as a length of time) of a second period of time for prediction of CSI by the WTRU, wherein the size of the second period of time is smaller or equal to a maximum size of the second period of time, and wherein the second period of time is after the first period of time (1810).

According to embodiments, the WTRU 102 may be configured to receive during the first period of time, from the network node, a plurality of CSI-RSs (1820).

According to embodiments, the WTRU 102 may be configured to measure a plurality of CSI based on the plurality of CSI-RS received (1830).

According to embodiments, the WTRU 102 may be configured to determine an updated size of the second period of time, wherein the updated size of the second period of time is based on a measurement performed on at least one of the CSI-RS of the plurality of CSI-RS received, and wherein the updated size of the second period of time is smaller or equal to the maximum size of the second period of time (1840).

According to embodiments, the WTRU 102 may be configured to transmit, to the network node, the updated size of the second period of time and a plurality of predicted CSI for the first period of time, wherein the plurality of predicted CSI may be generated using the plurality of CSI (1850).

According to embodiments, any of the following actions may be repeated periodically after an expiry of the first period of time: receive, during a third period of time from the network node, a second plurality of CSI-RSs; measure a second plurality of CSI based on the second plurality of CSI-RS; determine an updated size of a fourth period of time, wherein the updated size of the fourth period of time may be based on a measurement performed on at least one CSI-RS of the second plurality of CSI-RS, and wherein the updated size of the fourth period of time may be smaller or equal to the maximum size of the second period of time; and transmit, to the network node, the updated size of the fourth period of time and a second plurality of predicted CSI for the second period of time, wherein the second plurality of predicted CSI may be generated using the second plurality of CSI.

According to embodiments, the plurality of predicted CSI may be transmitted in a single transmission.

According to embodiments, the WTRU may be configured to: transmit, to the network node, information indicating a completion of the generation of the predicted CSI.

According to embodiments, the WTRU may be configured to: transmit, to the network node a request for an uplink grant; receive, from the network node, an uplink grant; and transmit, to the network node using the uplink grant, a report comprising the plurality of predicted CSI.

According to embodiments, the determination of the updated size of the second period of time is based on the uplink grant.

According to embodiments, WTRU may be configured to: receive from the network node, a request message for obtaining a capability of the WTRU to perform CSI prediction; and transmit, to the network node, a response message comprising information indicating the maximum size of the second period of time.

According to embodiments, the WTRU may be configured to: determine, for at least one CSI-RS of the plurality of CSI-RS received, a differential between a predicted CSI generated using the at least one CSI-RS and a CSI measurement based on the at least one CSI-RS; and transmit, to the network node, information indicating the differential.

According to embodiments, the plurality of predicted CSI is generated using a trained CSI prediction AI/ML model.

According to embodiments, the maximum size of the second period of time is based on a performance of the trained a CSI prediction AI/ML model.

According to embodiments, the WTRU may be configured to: transmit, to the network node, a request for updating and/or retraining the CSI prediction AI/ML model.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
receiving, from a network node, configuration information indicating:
a first period of time to receive and measure channel state information (CSI) by the WTRU, and
a size of a second period of time for prediction of CSI by the WTRU, wherein the size of the second period of time is smaller or equal to a maximum size of the second period of time, and wherein the second period of time is after the first period of time;
receiving, during the first period of time from the network node, a plurality of CSI reference signals (CSI-RSs);
measuring a plurality of CSI based on the plurality of CSI-RS;
determining an updated size of the second period of time, wherein the updated size of the second period of time is based on a measurement performed on at least one CSI-RS of the plurality of CSI-RS received, and wherein the updated size of the second period of time is smaller or equal to the maximum size of the second period of time; and
transmitting, to the network node, the updated size of the second period of time and a plurality of predicted CSI for the first period of time, wherein the plurality of predicted CSI is generated using the plurality of CSI.

2. The method according to claim 1, comprising:
after an expiry of the first time period of time, repeating periodically:
receiving, during a third period of time from the network node, a second plurality of CSI-RSs;
measuring a second plurality of CSI based on the second plurality of CSI-RS;
determining an updated size of a fourth period of time, wherein the updated size of the fourth period of time is based on a measurement performed on at least one CSI-RS of the second plurality of CSI-RS, and wherein the updated size of the fourth period of time is smaller or equal to the maximum size of the second period of time; and
transmitting, to the network node, the updated size of the fourth period of time and a second plurality of predicted CSI for the second period of time, wherein the second plurality of predicted CSI is generated using the second plurality of CSI.

3. The method according to claim 1, wherein the plurality of predicted CSI is transmitted in a single transmission.

4. The method according to claim 1, comprising:
transmitting, to the network node, information indicating a completion of a generation of the predicted CSI.

5. The method according to claim 1, comprising:
transmitting, to the network node, a request for an uplink grant;
receiving, from the network node, an uplink grant; and
transmitting, to the network node using the uplink grant, a report comprising the plurality of predicted CSI.

6. The method according to claim 5, wherein determining the updated size of the second period of time is further based on the uplink grant.

7. The method according to claim 1, comprising:
receiving, from the network node, a request message for obtaining a capability of the WTRU to perform CSI prediction; and
transmitting, to the network node, a response message comprising information indicating the maximum size of the second period of time.

8. The method according to claim 1, comprising:
determining, for at least one CSI-RS of the plurality of CSI-RS received, a differential between a predicted CSI generated using the at least one CSI-RS and a CSI measurement based on the at least one CSI-RS; and
transmitting, to the network node, information indicating the differential.

9. The method according to claim 1, wherein the plurality of predicted CSI is generated using a trained CSI prediction artificial intelligence (AI)/machine learning (ML) model.

10. The method according to claim 9, wherein the maximum size of the second period of time is based on a performance of the trained CSI prediction AI/ML model.

11. The method according to claim 9, further comprising:
transmitting, to the network node, a request for updating and/or retraining the CSI prediction AI/ML model.

12. A wireless transmit/receive unit (WTRU) comprising circuitry, including a transmitter, a receiver, a processor and memory, the WTRU configured to:
receive, from a network node, configuration information indicating:
a first period of time to receive and measure channel state information (CSI), and
a size of a second period of time for prediction of CSI by the WTRU, wherein the size of the second period of time is smaller or equal to a maximum size of the second period of time, and wherein the second period of time is after the first period of time;
receive, during the first period of time from the network node, a plurality of CSI reference signals (CSI-RSs);
measure a plurality of CSI based on the plurality of CSI-RS;
determine an updated size of the second period of time, wherein the updated size of the second period of time is based on a measurement performed on at least one CSI-RS of the plurality of CSI-RS, and wherein the updated size of the second period of time is smaller or equal to the maximum size of the second period of time; and
transmit, to the network node, the updated size of the second period of time and a plurality of predicted CSI for the first period of time, wherein the predicted CSI are generated using the plurality of CSI.

13. The WTRU according to claim 12, configured to:
after an expiry of the first time period of time, periodically repeat the following:
receive, during a third period of time from the network node, a second plurality of CSI-RSs;
measure a second plurality of CSI based on the second plurality of CSI-RS;
determine an updated size of a fourth period of time, wherein the updated size of the fourth period of time is based on a measurement performed on at least one of the CSI-RS of the second plurality of CSI-RS, and wherein the updated size of the fourth period of time is smaller or equal to the maximum size of the second period of time; and
transmit, to the network node, the updated size of the fourth period of time and a second plurality of predicted CSI for the second period of time, wherein the second plurality of predicted CSI is generated using the second plurality of CSI.

14. The WTRU according to claim 12, wherein the plurality of predicted CSI is transmitted in a single transmission.

15. The WTRU according to claim 12, configured to:
transmit, to the network node, information indicating a completion of a generation of the predicted CSI.

16. The WTRU according to claim 12, configured to:
transmit, to the network node, a request for an uplink grant;
receive, from the network node, an uplink grant; and
transmit, to the network node using the uplink grant, a report comprising the plurality of predicted CSI.

17. The WTRU according to claim 16, wherein the determination of the updated size of the second period of time is further based on the uplink grant.

18. The WTRU according to claim 12, configured to:
receive, from the network node, a request message for obtaining a capability of the WTRU to perform CSI prediction; and
transmit, to the network node, a response message comprising information indicating the maximum size of the second period of time.

19. The WTRU according to claim 12, configured to:
determine, for at least one CSI-RS of the plurality of CSI-RS received, a differential between a predicted CSI generated using the at least one CSI-RS and a CSI measurement based on the at least one CSI-RS; and
transmit, to the network node, information indicating the differential.

20. The WTRU according to claim 12, wherein the plurality of predicted CSI is generated using a trained CSI prediction artificial intelligence (AI)/machine learning (ML) model.

21-22. (canceled)
